(19) United States
(12) Patent Application Publication
(10) Pub. No.: US 2011/0105215 A1
(43) Pub. Date: May 5, 2011

(54) Gaming machine

(75) Inventor: Hayato Mizue, Sagamihara-shi (JP)

(73) Assignee: Konami Gaming, Inc., Las Vegas, NV (US)

(21) Appl. No.: 12/590,128

(22) Filed: Nov. 2, 2009

(51) Int. Cl. A63F 9/24; A63F 13/00

(52) U.S. Cl. 463/20; 463/30

(57) ABSTRACT

The gaming machine includes a display and a controller. The display shows symbols that are placed in cells. The symbols contain a specific type of symbol that is placed in a specific cell. The controller controls movements of the symbols and the cells. The specific cell has a gauge. A value indicated by the gauge represents a count of how many times the specific cell appears in the display. The controller compares the value of the gauge with a threshold value. And, a favorable condition to a player is arranged to be initiated when the value of the gauge has reached the threshold value.

### TECHNICAL FIELD

The present invention relates to gaming machines such as slot machines, video slot machines and so on that are popularly played in casinos, pachisuro parlors and other locations.

### BACKGROUND OF THE INVENTION

Video slot machines, often just called video slots are popular gaming machines in casinos and attract many players. While mechanical slot machines, or also called stepper have mechanical reels, video slots show imaginary reels in their displays. In a typical video slot, symbol images are aligned in columns and rows on its display. Once the player bets a credit, the symbols move from top to bottom as if reels are rotating in the display. Then, symbols stop after a while. When some symbols are aligned in a specific combination, the player can get back the bet credit sometimes multiplied by dozens or even hundreds of times. Such occasional big wins make the video slots exciting.

The advantage of the video slots is that since all the important components necessary for the games are generated as images on the display, they can provide more diverse game rules than slot machines. In addition, more stimulating visual effects and animations are easy to produce. Such features enable the video slots to provide very entertaining games. Although hundreds of thousands of video slots have been manufactured so far, the video slots still have a big potential to be more exciting and entertaining, utilizing software technologies.

### SUMMARY OF THE INVENTION

An aspect of the present invention being a gaming machine includes a display and a controller. The display shows symbols that are placed in cells. The symbols contain a specific type of symbol that is placed in a specific cell. The controller controls movements of the symbols and the cells. The specific cell has a gauge. A value indicated by the gauge represents a count of how many times the specific cell appears in the display. The controller compares the value of the gauge with a threshold value. And, a favorable condition to a player is arranged to be initiated when the value of the gauge has reached the threshold value.

Another aspect of the present invention being a gaming machine includes a display and a controller. The display shows symbols aligned along reels. The symbols contain a specific type of symbols. The controller controls movements of the symbols. Each of the specific type of symbols has a gauge, which indicates a value. When one of the specific type of symbols appears in the display, a certain value is added to values of gauges of specific type of symbols in a reel where the one of the specific type of symbols has appeared in the display. The controller compares the values of the gauges with a threshold value. And, a favorable condition to a player is arranged to be initiated when a value of one of the gauges has reached the threshold value.

Another aspect of the present invention being a gaming machine includes a display, a controller, a counter, a plurality of gauges, and a memory. The display shows groups of symbols that contain at least a specific type of symbols. The symbols are aligned along a plurality of reels. The controller controls movements of the reels on the display. The counter counts numbers of times that the specific type of symbols appears on the display. The appearance of the specific type of symbols owes to the movement of the reels. Each of the plurality of gauges is placed in a symbol area where each of the specific type of symbols is located. Each of the gauges reflects each of the numbers counted by the counter. The memory memorizes the numbers counted by the counter. When at least one of the numbers in the memory has reached a threshold, the controller increases a winning chance by changing symbols in the reel whose associated number in the memory has reached the threshold.

### BRIEF DESCRIPTION OF THE DRAWINGS

FIG. 1 is a perspective view displaying an example of a gaming machine of the present invention.

FIG. 2 is a block diagram depicting input/output connections between the components of the gaming machine shown in FIG. 1.

FIG. 3 is a display image to explain Example 1 of the present invention.

FIG. 4 is a display image to explain Example 1 of the present invention.

FIG. 5 is a display image to explain Example 1 of the present invention.

FIG. 6 is a display image to explain Example 1 of the present invention.

FIG. 7 is a display image to explain Example 1 of the present invention.

FIG. 8 is a display image to explain Example 1 of the present invention.

FIG. 9 is a flowchart describing an operation of Example 1 of the present invention.

FIG. 10 is a display image to explain Example 2 of the present invention.

FIG. 11 is a display image to explain Example 2 of the present invention.

FIG. 12 is a flowchart describing an operation of Example 2 of the present invention.

FIG. 13 is a display image to explain Example 3 of the present invention.

FIG. 14 is a display image to explain Example 3 of the present invention.

FIG. 15 is a flowchart describing an operation of Example 3 of the present invention.

FIG. 16 is a display image to explain Example 4 of the present invention.

FIG. 17 is a display image to explain Example 4 of the present invention.

FIG. 18 is a display image to explain Example 4 of the present invention.

FIG. 19 is a flowchart describing an operation of Example 4 of the present invention.

FIG. 20 is a display image to explain Example 5 of the present invention.

FIG. 21 is a display image to explain Example 5 of the present invention.

FIG. 22 is a display image to explain Example 5 of the present invention.

FIG. 23 is a flowchart describing an operation of Example 5 of the present invention.

FIG. 24 is a display image to explain Example 6 of the present invention.

FIG. 25 is a display image to explain Example 6 of the present invention.

FIG. 26 is a flowchart describing an operation of Example 6 of the present invention.

FIG. 27 is a display image to explain Example 7 of the present invention.

FIG. 28 is a display image to explain Example 7 of the present invention.

FIG. 29 is a display image to explain Example 7 of the present invention.

FIG. 30 is a flowchart describing an operation of Example 7 of the present invention.

### DETAILED DESCRIPTION OF INVENTION

Below, a gaming machine of the present invention will be described in detail based on specific examples.

### §1. ARCHITECTURE OF THE GAMING MACHINE 1

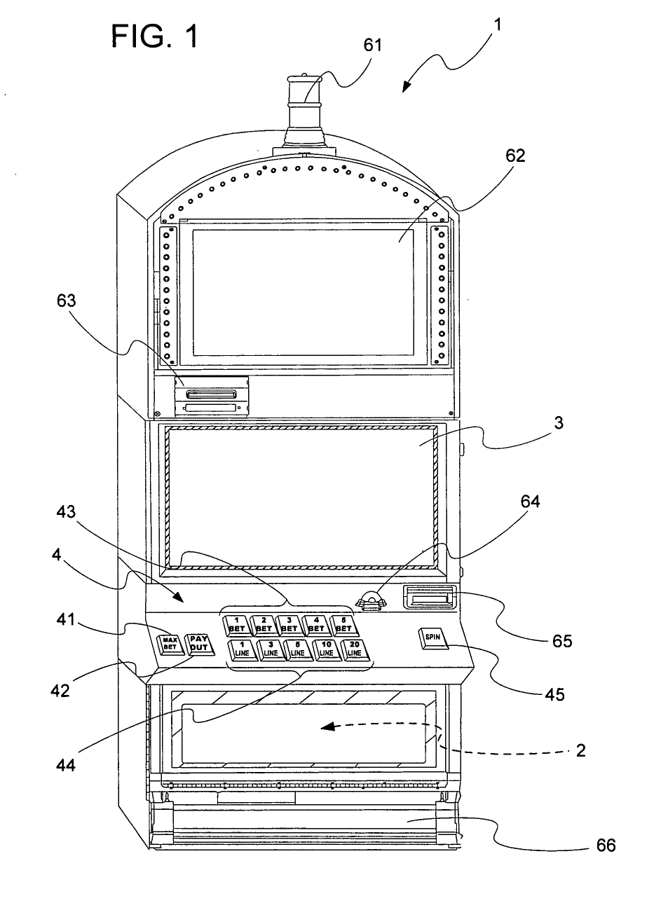

FIG. 1 is a perspective view showing an example of a gaming machine of the present invention. The gaming machine 1 is so called a video slot, in which symbols are shown in columns and rows as an image on its display. Once a player bets a credit and instructs to spin imaginary reels, the symbols move from top to bottom in the display and stop after a while. When the symbols align in a specific combination, the player can get back the credit as a reward.

As shown in FIG. 1, the gaming machine 1 has an emergency lamp 61, an advertisement board 62, a card slot 63, a display 3, a coin slot 64, a bill acceptor 65, buttons 4 and a payout tray 66. The gaming machine 1 also has a controller 2 internally.

On the top of the gaming machine 1 stands the emergency lamp 61. It is arranged to light on when a trouble happens somewhere on or in the gaming machine 1. The advertisement board 62 is located on the upper part of the gaming machine 1. It shows catchy illustrations and messages that attract potential players. The card slot 63 is provided below the advertisement board 62. It accepts a player's card which records information about the player. The card slot 63 also reads and writes the player's information on the player's card.

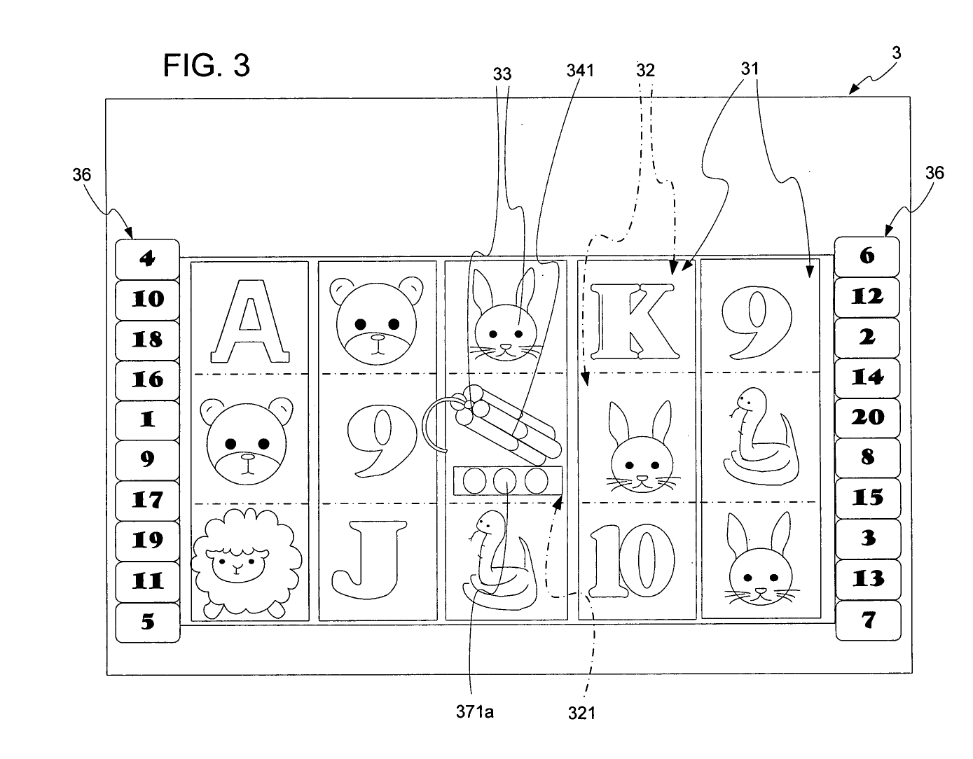

Below the card slot 63 lies the display 3. This shows images that make up the game like FIG. 3. The players are supposed to play games on the gaming machine 1, watching images and messages on the display 3.

Below the display 3, the coin slot 64 and the bill acceptor 65 are provided. The player can insert coins into the coin slot 64 and bills or a credit card into the bill acceptor 65. Once the slot machine 1 accepts the money, the amount of money is converted to an amount of credit. With this credit, the gaming machine 1 provides fun slot games to the player.

The buttons 4 are also provided below the display 3. The buttons 4 are constituted with a MAX BET button 41, a PAYOUT button 42, BET buttons 43, LINE buttons 44 and a SPIN button 45. The BET buttons 43 are arranged from a 1 BET button to a 5 BET button from left to right. The numbers written on the BET buttons 43 correspond to the bet amounts for one pay line. For example, the player can bet one credit per pay line by pushing the 1 BET button, two credits per pay line by pushing the 2 BET button and three credits per pay line by pushing the 3 BET button. The MAX BET button 41 allows the player to bet the maximum amount of credit that is permitted in the game. Parallel to the BET buttons 43, the LINE buttons 44 are arranged. The LINE buttons 44 are arranged from a 10 LINE button to a 50 LINE button from left to right. The numbers written on the LINE buttons 44 correspond to the number of pay lines the gaming machine 1 activates. For example, the player pushes the 10 LINE button when he/she wants to activate 10 pay lines for the game and the player pushes the 20 LINE button when he/she wants to activate 20 pay lines. The SPIN button 45 is provided to initiate the game after the player selects the bet amount and pay lines. Once the player presses the SPIN button 45, the symbols in the display start to spin. The PAYOUT button 42 is provided to return money to the player based on the amount of credit remained in the gaming machine 1. When the player finishes the game and wants to leave the gaming machine 1, the player pushes the PAYOUT button 42. Then, a voucher is printed out from the payout tray 66, which is located near the bottom of the gaming machine 1.

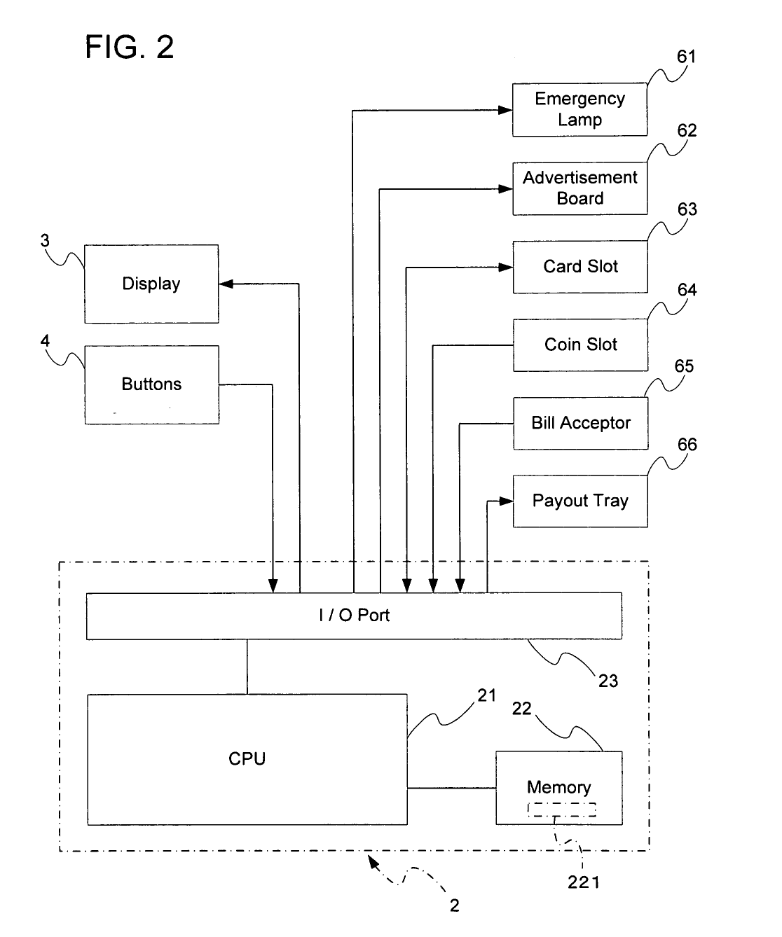

All the components of the gaming machine 1 described above are controlled by the controller 2, which is installed inside of the gaming machine 1. FIG. 2 is a block diagram illustrating input/output connections between the components of the gaming machine 1. As shown in this figure, the display 3, the buttons 4, the emergency lamp 61, the advertisement board 62, the card slot 63, the coin slot 64, the bill acceptor 65, and the payout tray 66 are all electrically connected to the controller 2. The controller 2 is composed of a central processing unit (CPU) 21, a memory 22 and an input/output (I/O) port 23. The CPU 21 is arranged to run a computer program written in the memory 22. The memory 22 is designed not only to provide the program to the CPU 21 but also to store temporary data including values sent from the CPU 21. Based on the program and data stored in the memory 22 and inputs from the buttons 4, the card slot 63, the coin slot 64 and the bill acceptor 65 via the I/O port 23, the CPU 21 generates timely image of the game. Then, the generated image is shown on the display 3 as an output. The CPU 21 also moves image components, such as cells and symbols, shown on the display 3. Since the CPU 21 generates concrete and substantial slot images on the display 3, the player recognizes the game as real. When necessary, the CPU 21 also outputs control signals to the emergency lamp 61, advertisement board 62, card slot 63 and payout tray 66 via the I/O port 23 for proper operation of the gaming machine 1. Accordingly, in the gaming machine 1, the game is substantially controlled by the controller 2 generating timely game images on the display 3. Furthermore, all the Examples described below are substantially realized by software stored in the memory 22. Thus, the gaming machine 1 can carry out all the Examples described below without replacing the hardware components, by just running a selected program written in the memory 22.

### §2. EXAMPLE 1

In this section, Example 1 will be explained, using FIGS. 3-9.

### §2.1. DESIGN OF EXAMPLE 1

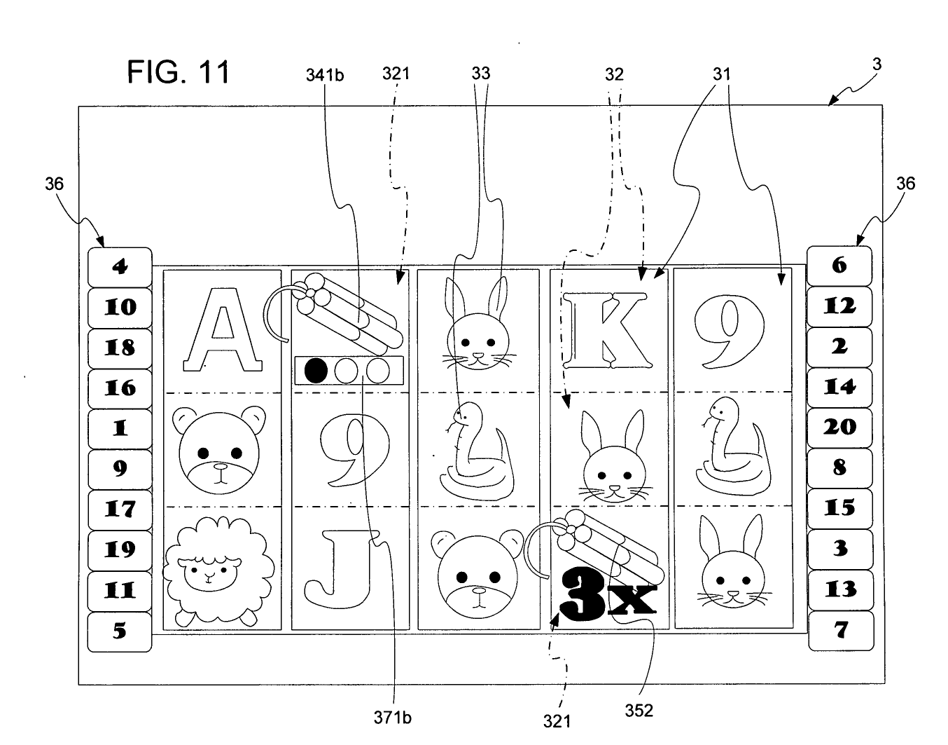

FIG. 3 is a basic image of Example 1. As shown in this figure, the display 3 shows reels 31 and pay line marks 36. The reels 31 are located in the center of the display 3. The reels 31 are made up of five reels. Each reel 31 has cells 32, which are aligned in rows and three of which are shown in the display 3. Each cell 32 has a symbol 33. Each symbol 33 represents a specific image (such as bear, rabbit, sheep or snake), letter (such as A, J, K or 9) or their combination (such as a multiplier symbol 352 in FIG. 11). Since each cell 32 has one symbol 33 in this Example, the cells 32 and the symbols 33 are aligned by three in rows and five in columns, each column corresponding to each reel 31 in the display 3.

The symbols 33 contain a specific symbol 341, which is a specific type of symbol. In this Example, the specific symbol 341 represents a dynamite image and functions as a wild symbol, which is compatible to any types of the symbols 33 to constitute a winning line. In this embodiment, the cell 32 that contains the specific symbol 341 is referred as a specific cell 321. In other word, each specific cell 321 contains a specific symbol 341. In addition, the specific cell 321 contains a gauge 371a, which indicates a value. In FIG. 3, the gauge 371a contains three white circles. Each white circle represents a value ‘zero’. Thus, the gauge 371a in the specific cell 321 in FIG. 3 indicates a value ‘zero’.

Outside of the reels 31 lie pay line marks 36 so that they sandwich the reels 31 between them. When the player plays the game, he/she selects the pay lines, pushing one of the LINE buttons 44. According to the buttons the player presses, some of the numbers in the pay line marks 36 are activated. Each number in the pay line marks 36 represents a specific pay line that runs all the reels 31 from left to right and that runs one of the three rows in each reel 31. When some symbols 33 align on the activated pay line in a specific combination, the player wins.

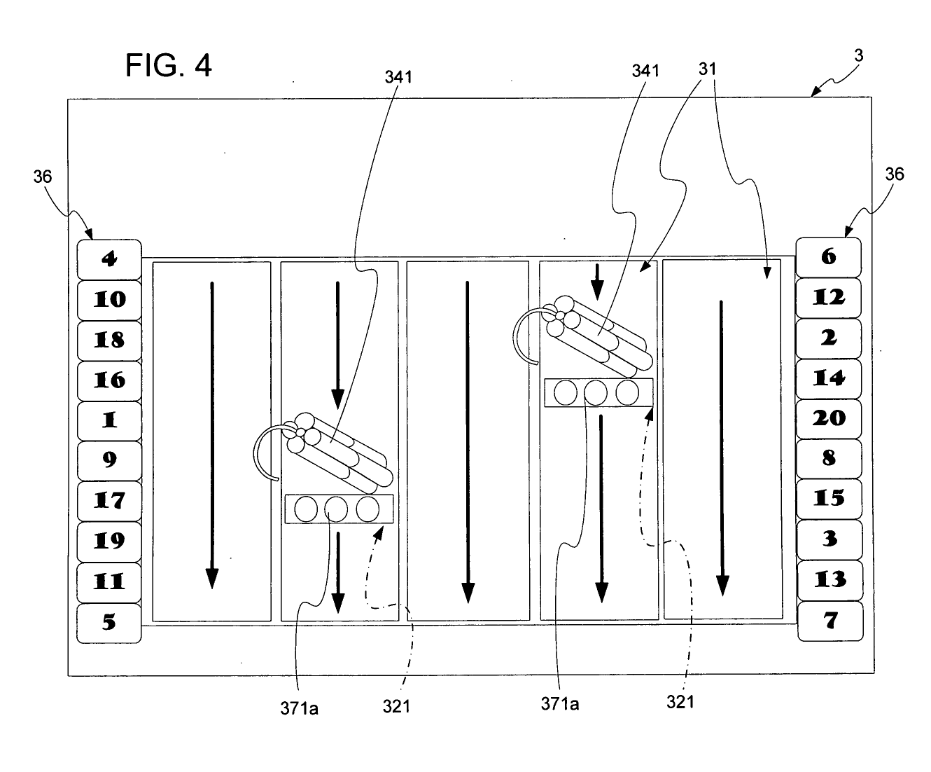

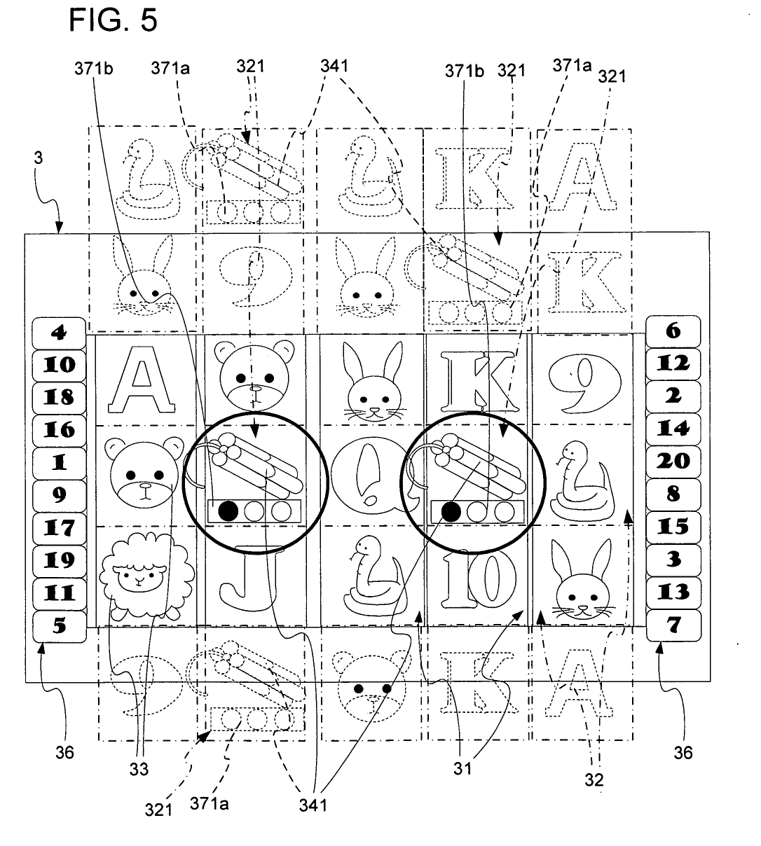

When the player pushes one of the BET buttons 43 or the MAX BET button 41 as well as one of the LINE buttons 44, the gaming machine 1 is ready to provide a game. Then, when the player pushes the SPIN button 45, the gaming machine 1 begins to move the cells 32 and the symbols 33 from top to bottom as shown in FIG. 4 as if the reels 31 are rotating from top to bottom in the display 3. At this time, the specific cells 321 containing the specific symbols 341 and the gauges 371a move together with other cells 32 and symbols 33 in the reel 31. After a while, the gaming machine 1 stops the movement of the cells 32 reel by reel. Then, the arrangement of the symbols 33 may change, for example, like FIG. 5. Please note that FIG. 5 shows not only the cells 32 and the symbols 33 in the display 3 but also the cells 32 and the symbols 33 outside of the area shown in the display 3.

When the specific cell 321 shows up in the display 3, a value such as ‘one’ is added to the gauge 371a that have shown up in the display 3, turning the gauge 371a into a gauge 371b. As shown in FIG. 5, in the display 3, since the value ‘one’ is added to the gauge 371b, one white circle is replaced with one black circle, which represents a value ‘one’. However, in the gauge 371a that are outside of the display 3, in other word that are not shown in the display 3, the value is not added to the gauges 371a. Thus, in FIG. 5, the values of the gauges 371a that are outside of the display 3 remain ‘zero’. Since the certain value is added only in the gauge 371 that showed up in the display 3 and the value is not added in the gauge 371 that is outside of the display 3, the value of each gauge 371 in a reel 31 changes independently from values of other gauges 371.

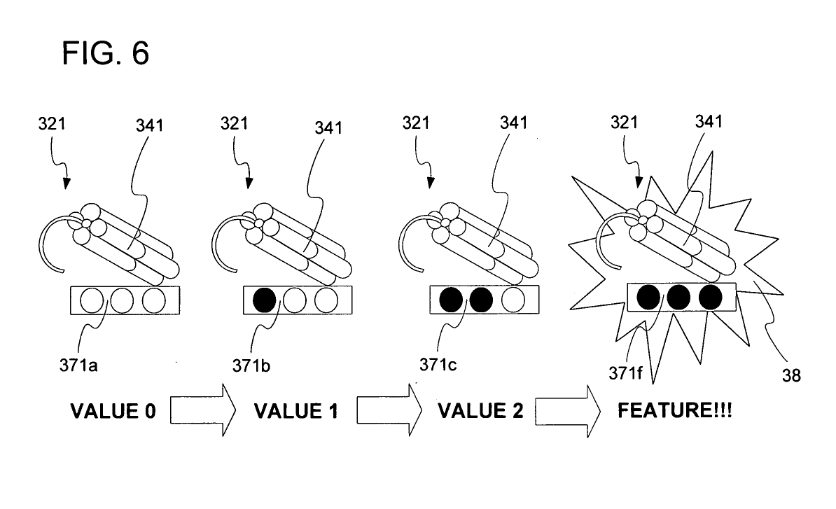

As shown in FIG. 6, as the specific cell 321 shows up in the display 3, a value ‘one’ is added to the gauge 371 each time. Therefore, the value represented by the gauge 371 is incremented from ‘zero’ to ‘one’, ‘one’ to ‘two’ and ‘two’ to ‘three’ gradually, changing the gauge 371a into gauge 371b, gauge 371c and gauge 371f. As a result, the value indicated by the gauge 371 represents a count of how many times the specific cell 321 has appeared in the display 3.

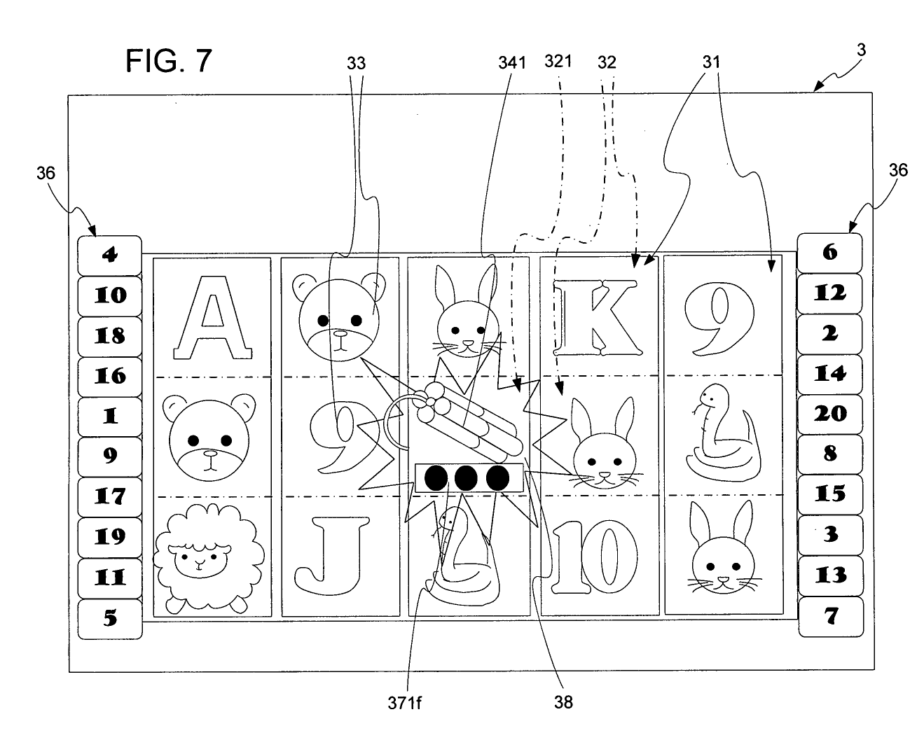

As shown in FIGS. 6 to 7, when the value of the gauge 371f reaches a threshold value, which is ‘three’ in this Example, a visual effect 38, which represents explosion in this Example, is shown on the specific cell 321. Then, a feature, which is a favorable condition to a player, is initiated.

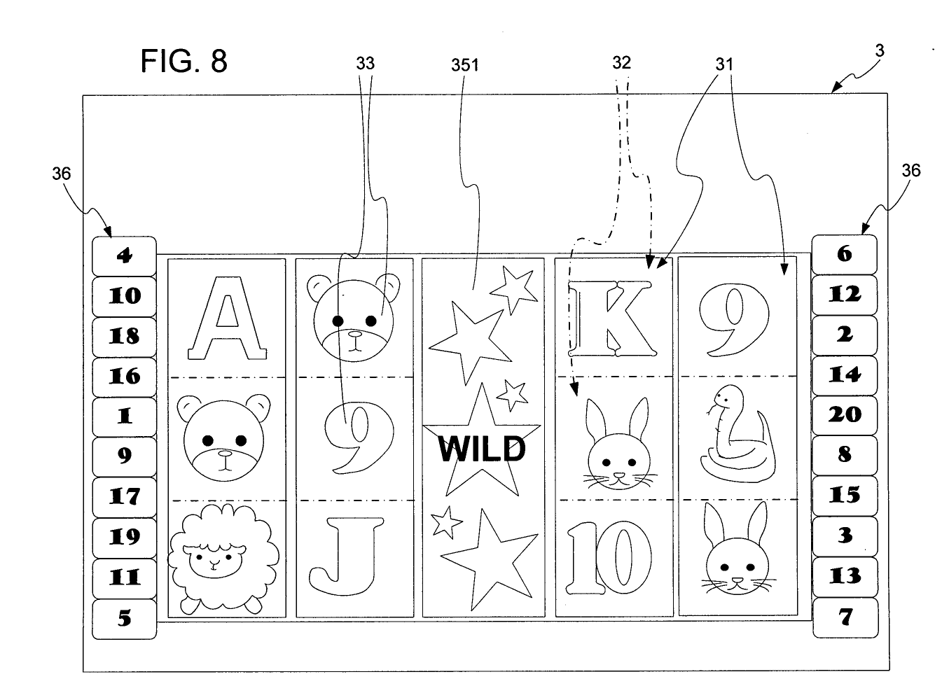

As shown in FIG. 8, in this Example, all the symbols 33, in a reel 31 in which the gauge 371f have reached the threshold, change into an entire reel wild symbol 351. The entire reel wild symbol 351 is a symbol that functions as a wild symbol in all the rows in a reel 31 in the display 3. Therefore, a winning amount is calculated as if each cell 32 in the reel 31 where the entire reel wild symbol 351 showed up has a wild symbol. After the payout, the entire reel wild symbol 351 turns back to the original symbols 33 with the value of the gauge 371 being reset to be a default value, which is ‘zero’ in this Example.

### §2.2. OPERATION OF EXAMPLE 1

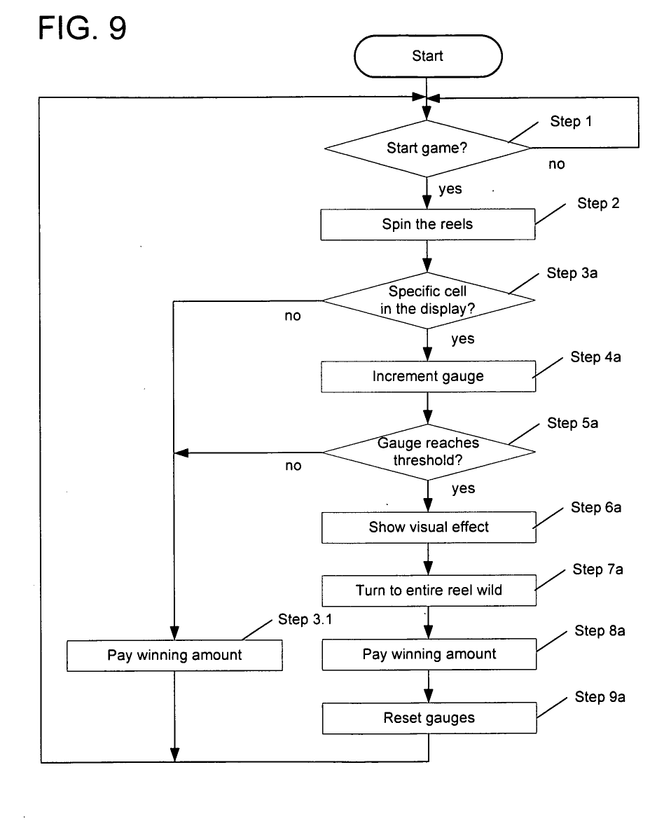

Next, the operation of the gaming machine 1 in this Example will be explained based on FIG. 9.

To run a below operation, the gaming machine 1 needs to count the number of how many times each of the specific cells 321 shows up in the display 3 and memorize it as a data. To do so, as shown in FIG. 2, the controller 2 has a counter 221 in a certain area of the memory 22. In other words, the controller 2 assigns a specific area in the memory 22 as a counter 221 that memorizes the value corresponding to the number of how many times each of the specific cells 321 shows up in the display 3.

Upon starting the game, the below operation premises the fact that the player paid a money to the gaming machine 1 and the gaming machine 1 converted the accepted money to a certain amount of credit.

<Step 1>: When the gaming machine 1 receives an instruction to start a game from the player, the operation shifts from Step 1 to Step 2. This instruction is composed of pressing the following three buttons by the player: 1) one of the BET buttons 43 or MAX BET button 41, 2) one of the LINE buttons 44 and 3) the SPIN button 45. Unless the player instructs to initiate the game, the gaming machine 1 stalls at Step 1. At this Step, the image on the display 3 may be the one as shown in FIG. 3.

<Step 2>: Once the SPIN button 45 is pressed by the player, the gaming machine 1 spins the reels 31. The cells 32 and the symbols 33 move together according to the movement of the reels 31. During the spin, the image on the display 3 may be the one as shown in FIG. 4. After a while, the gaming machine 1 stops the reels 31.

<Step 3a>: The gaming machine 1 determines whether the specific cell 321 is in the display 3. If there is no specific cell 321, the operation branches to Step 3.1. If there is a specific cell 321 in the display 3 as shown in FIG. 5, the operation forwards to Step 4a.

<Step 3.1>: The gaming machine 1 calculates the winning amount of the game based on the combinations of the symbols 33 aligned on the activated pay lines. Then, the gaming machine 1 returns the winning amount of credit to the player if the winning amount is not zero. Then, the operation goes back to Step 1.

<Step 4a>: The gaming machine 1 increments the value in the counter 221 that corresponds to the specific cell 321 that showed up in the display 3. Also, the gaming machine 1 reflects the values stored in the counter 221 to the gauge 371. Thereby, some white circle in the gauge 371 turns into black circle as shown in FIG. 5.

<Step 5a>: The gaming machine 1 compares the value of the gauge 371 with the threshold value and determines whether the value of the gauge 371 has reached the threshold value. In other words, the gaming machine 1 determines whether the value in the counter 221 has reached the threshold value in each of the specific cells 321. If the value is below the threshold, the operation branches to Step 3.1. If the value is the same or above the threshold value, the operation proceeds to Step 6a.

<Step 6a>: The gaming machine 1 shows the visual effect 38 as shown in FIG. 7.

<Step 7a>: The gaming machine 1 changes the symbols 32 into the entire reel wild symbol 351 in the reel 31 in which the value of the gauge 371f has reached the threshold. Then, the image on the display 3 may be like FIG. 8.

<Step 8a>: The gaming machine 1 calculates the winning amount of the game as Step 3.1, assuming that all the symbols 32 in the reel 31, in which the value of the gauge 371f reached the threshold, are the wild symbols. Then, the gaming machine 1 returns the winning amount of credit to the player if the winning amount is not zero.

<Step 9a>: The gaming machine 1 resets the value in the counter 221 and the gauge 371f which was a subject of the feature, turning all the black circles back to white circles. Then, the operation returns to Step 1.

### §2.3. ADVANTAGE OF EXAMPLE 1

As described above, in this Example, the value represented by the gauge 371 increases gradually, the value representing a count of how many times the specific cell 321 has appeared in the display 3. It would be fun for the player to see that the value of the gauge 371 increases little by little. If the status of the gauge 371 is the gauge 371c or the like as shown in FIG. 6, the player couldn't help but imagine that an exciting event may happen soon. Therefore, the player would hesitate to leave the gaming machine 1 and may spend more money.

Furthermore, in this Example, the value of each gauge 371 in the reel 31 changes independently from values of other gauges. This arrangement makes it for the game designer to easily attenuate the game balance. For example, it is easy to set the game balance so that the game harmonizes player's benefit and casino's profit. Also, it is easy to design to increase the volatility of the game by arranging an occasional big win brought by the feature.

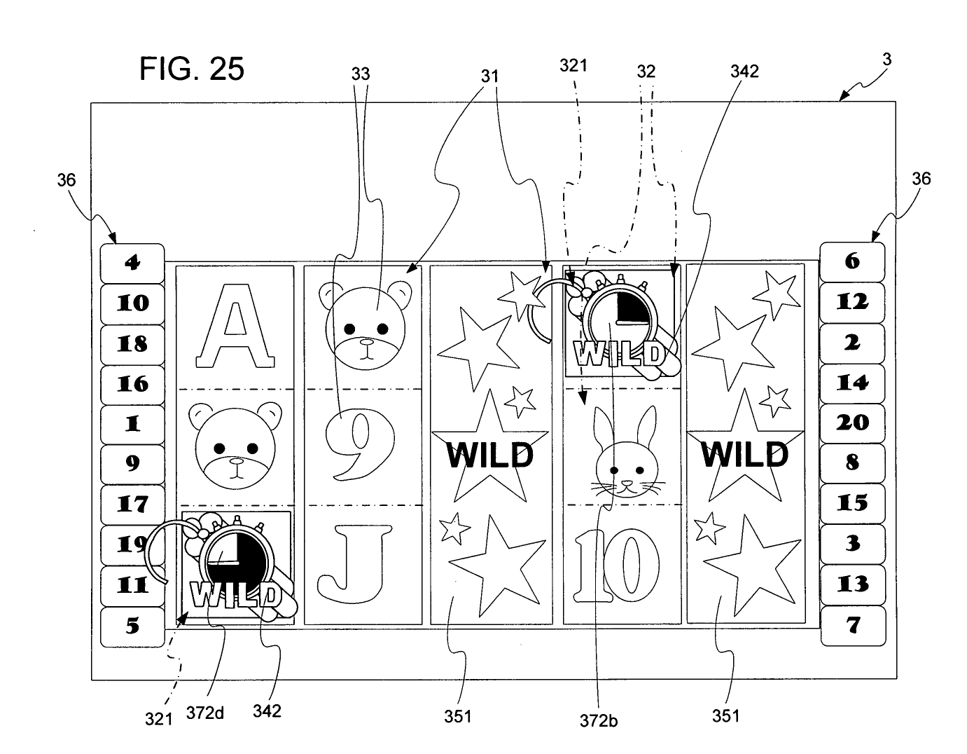

In this Example, the entire reel wild symbol 351 appeared as a feature to increases a winning chance of the player. The appearance of the entire reel wild symbol 351 makes the player expect to win a larger award and the game becomes more exciting. In a lucky case, plural entire reel wild symbols 351 may show up in the display 3 at the same time like FIG. 25. If such a situation happens in the actual game, the player will be ecstatic and enthralled and may be addicted to the gaming machine 1.

### §3. EXAMPLE 2

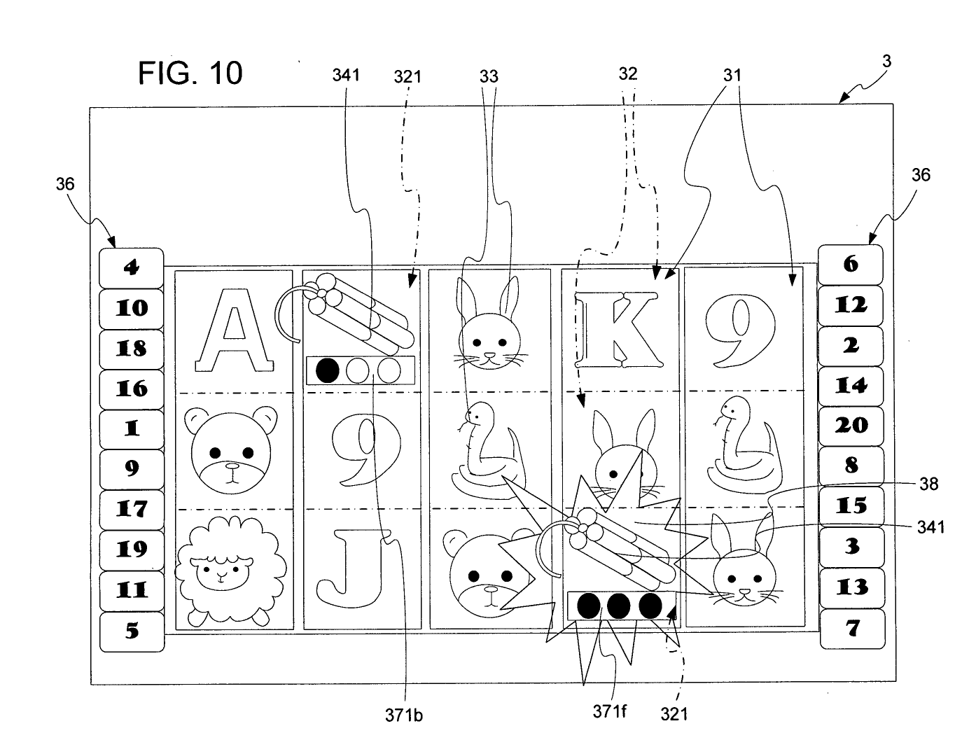

In this section, Example 2 will be explained, using FIGS. 10-12. Below, only the things that are different from the things in Example 1 will be explained and the same explanations will be omitted.

### §3.1. DESIGN OF EXAMPLE 2

As shown in FIGS. 10 to 11, in this Example, when the gauge 371 has reached the threshold value, the specific symbol 341 changes into a multiplier symbol 352 as a feature. The multiplier symbol 352 functions as a wild symbol. In addition, the multiplier symbol 352 increases the payout amount of credit when the multiplier symbol 352 is incorporated into a winning line. In the case of FIG. 11, the multiplier symbol 352 has a multiplier ‘3×’. A winning amount of credit is multiplied by the value represented by the multiplier symbol 352. Thus, in this Example, the payout amount is tripled if the multiplier symbol 352 is incorporated into a winning line.

After the appearance, the multiplier symbol 352 remains in several succeeding games. Thus, it may show up again in the display 3 in the next game. After several spins, the multiplier symbol 352 turns back to be a specific symbol 341 with a gauge 371a.

### §3.2. OPERATION OF EXAMPLE 2

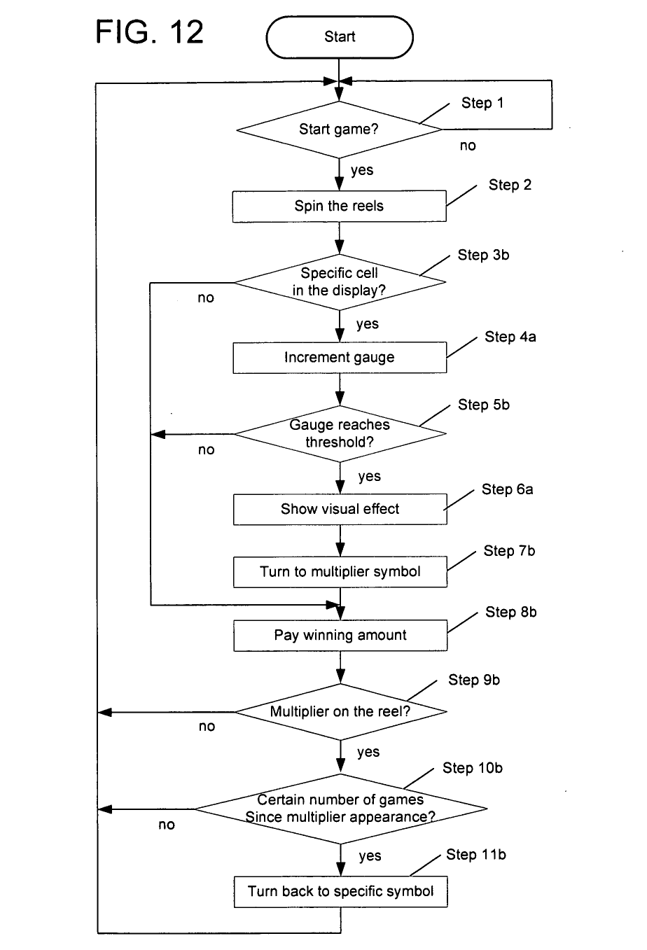

Below, only the operations that are different from those in Example 1 are described, using FIG. 12.

<Steps 1 & 2>: The gaming machine 1 starts a game and spins the reels 31.

<Step 3b>: The gaming machine 1 determines whether the specific cell 321 is in the display 3. If there is no specific cell 321, the operation branches to Step 8b. If there is a specific cell 321 in the display 3 as shown in FIG. 10, the operation forwards to Step 4a.

<Steps 4a>: The gaming machine 1 increments the value of the gauge 371 in the specific cell 321 that showed up in the display 3.

<Step 5b>: The gaming machine 1 determines whether the value of the gauge 371 has reached the threshold value. If the value is less than the threshold, the operation branches to Step 8b. If the value is equal to or greater than the threshold value, the operation proceeds to Step 6a.

<Step 6a>: The gaming machine 1 shows the visual effect 38 like FIG. 10.

<Step 7b>: The gaming machine 1 changes the specific symbol 341 into the multiplier symbol 352 in the specific cell 321 in which the value of the gauge 371f has reached the threshold value. Then, the image on the display 3 may be like FIG. 11.

<Step 8b>: The gaming machine 1 calculates the winning amount of the game as shown in Step 3.1 in the Example 1, counting the value of multiplier.

<Step 9b>: The gaming machine 1 determines whether the multiplier symbol 352 is on the reel 31. If there is no multiplier symbol 352, the operation returns to Step 1. If there is a multiplier symbol 352 on the reel 31, the operation proceeds to Step 10b.

<Step 10b>: The gaming machine 1 determines whether a certain number of games are performed since the multiplier symbol 352 appeared on the reel 31. If a certain number of spins have not been executed, the operation goes back to Step 1. If a certain number of spins have been executed, the operation proceeds to Step 11b.

<Step 11b>: The gaming machine 1 changes the multiplier symbol 352 back to the specific symbol 341 with the gauge 371a, and resets the value in the gauge 371 to be ‘zero’. Then, the operation goes back to Step 1.

### §3.3. ADVANTAGE OF EXAMPLE 2

In this Example, the specific symbol 341 is arranged to be changed into the multiplier symbol 352, which can enhance the winning amount of the game. Therefore, the game becomes more volatile and excitable.

### §3.4. MISCELLANEOUS REMARKS

In this Example, the multiplier symbol 352 remained in the games for several spins after its appearance. However, in other examples, the multiplier symbol 352 may turn back to the specific symbol 341 and the gauge 371a after paying the winning amount of credit once.

### §4. EXAMPLE 3

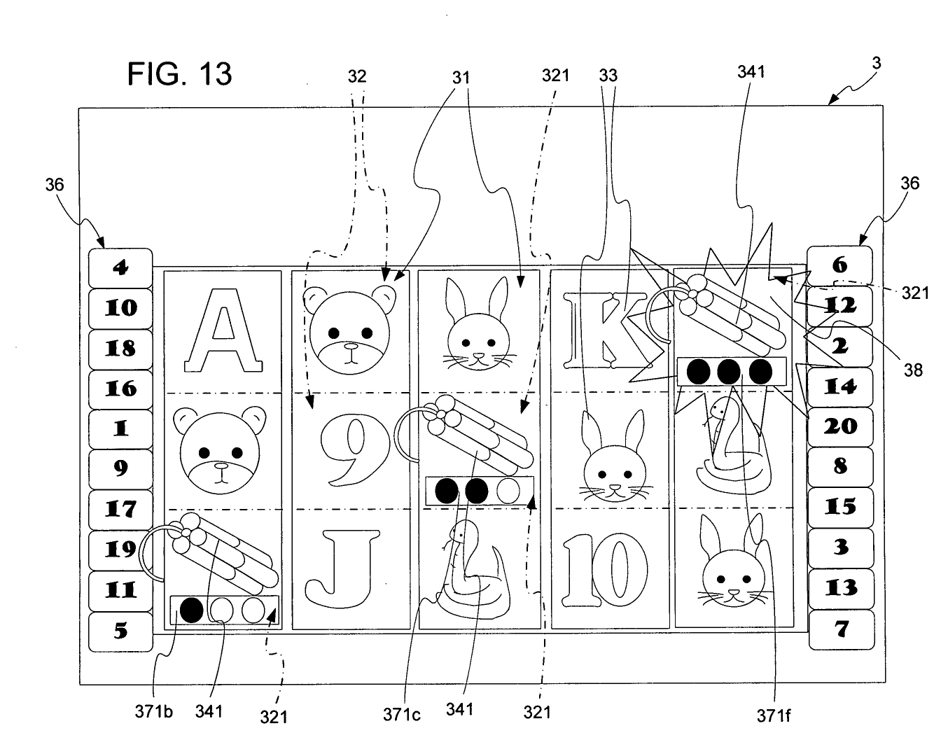

In this section, Example 3 will be explained, using FIGS. 13-15. Below, only the things that are different from the things in Example 1 are explained and the same explanations are omitted.

### §4.1. DESIGN OF EXAMPLE 3

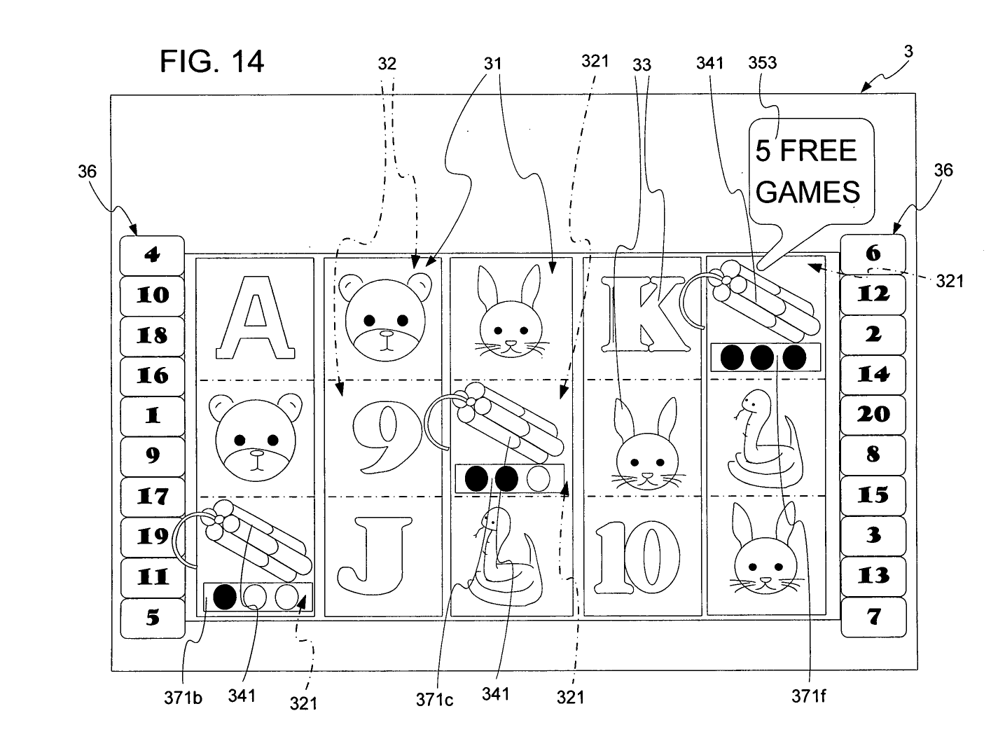

As shown in FIGS. 13 to 14, in this Example, when the value of the gauge 371 has reached the threshold value, a message 353 is shown on the display 3 and free games are provided to the player as a feature. During the free games, the player can spin the reels 31 a certain number of times and can win credits without paying a credit.

### §4.2. OPERATION OF EXAMPLE 3

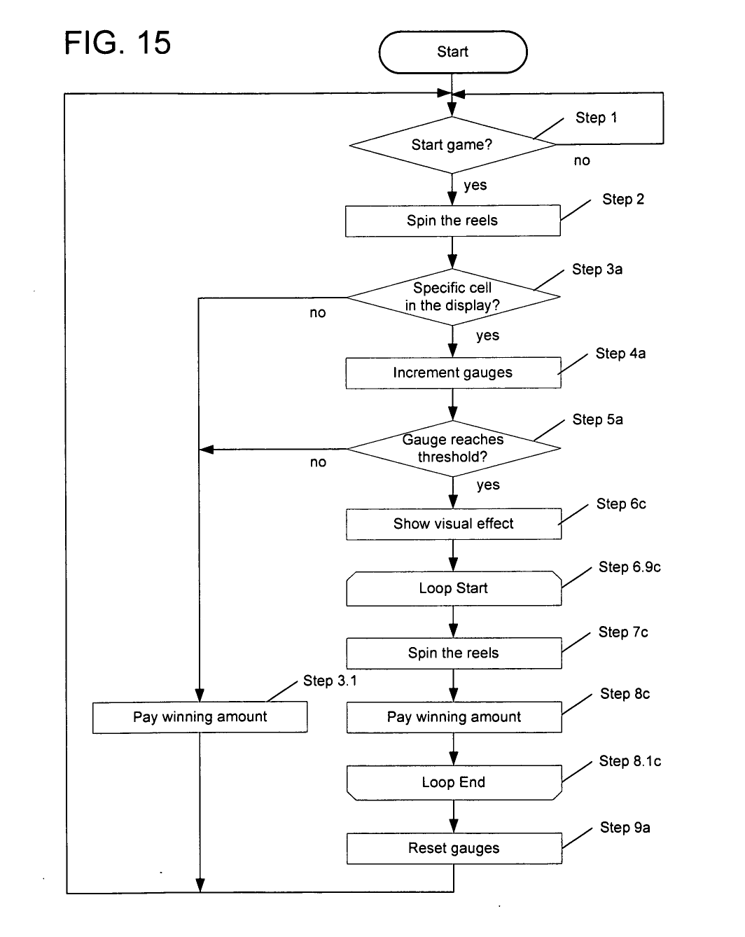

Below, only the operations that are different from those in Example 1 will be described, using FIG. 15.

<Steps 1-5a>: These steps are the same as the Steps 1-5a in Example 1.

<Step 6c>: The gaming machine 1 shows the visual effect 38 as shown in FIG. 13. Then, the gaming machine 1 shows the message 353 as shown in FIG. 14.

<Step 6.9c>: The gaming machine 1 repeats Steps 7c & 8c certain times based on the number of free games the gaming machine 1 provided to the player.

<Step 7c>: The gaming machine 1 spins the reels 31 as shown in Step 2 without accepting a credit.

<Step 8c>: The gaming machine 1 calculates the winning amount of the credit as Step 3.1.

<Step 8.1c>: The gaming machine 1 determines whether the predetermined number of free spins have been executed. If the predetermined number of free spins has not been provided to the player, the process returns to step 7c. If the predetermined number of free spins has been provided to the player, the process proceeds to step 9a.

<Step 9a>: The gaming machine 1 resets the value of the gauge 371f whose value has reached the threshold.

### §4.3. ADVANTAGE OF EXAMPLE 3

In this Example, free games were provided as a feature after the value of the gauge 371f reached the threshold value. This delights the player because the player can spin the reels without paying a credit.

### §4.4. MISCELLANEOUS REMARKS

In this Example, the values of gauges 371 were not incremented during the free spin. However, in other examples, the values of gauges 371 may be incremented and another feature may occur during the free spin.

### §5. EXAMPLE 4

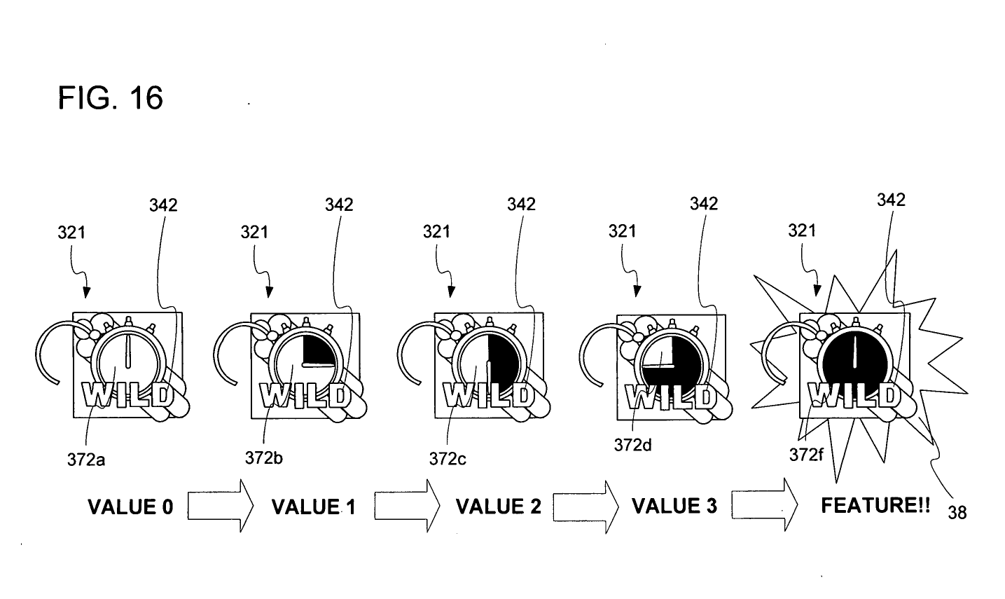

In this section, Example 4 will be explained, using FIGS. 16-19. Below, only the things that are different from the things in Example 1 will be explained and the same explanations will be omitted.

### §5.1. DESIGN OF EXAMPLE 4

In this Example, appearance of the gauge 372 is different from that in previous Examples. As shown in FIG. 16, the gauge 372 has an appearance that is similar to a clock. When the gauge 372 represents values ‘zero’, ‘one’, ‘two’, ‘three’ and ‘four’, the gauge 372 indicates 0, 3, 6, 9 and 12 o'clock respectively. When the value of the gauge 372f reaches a threshold value, which is ‘four’ in this Example, a feature is initiated.

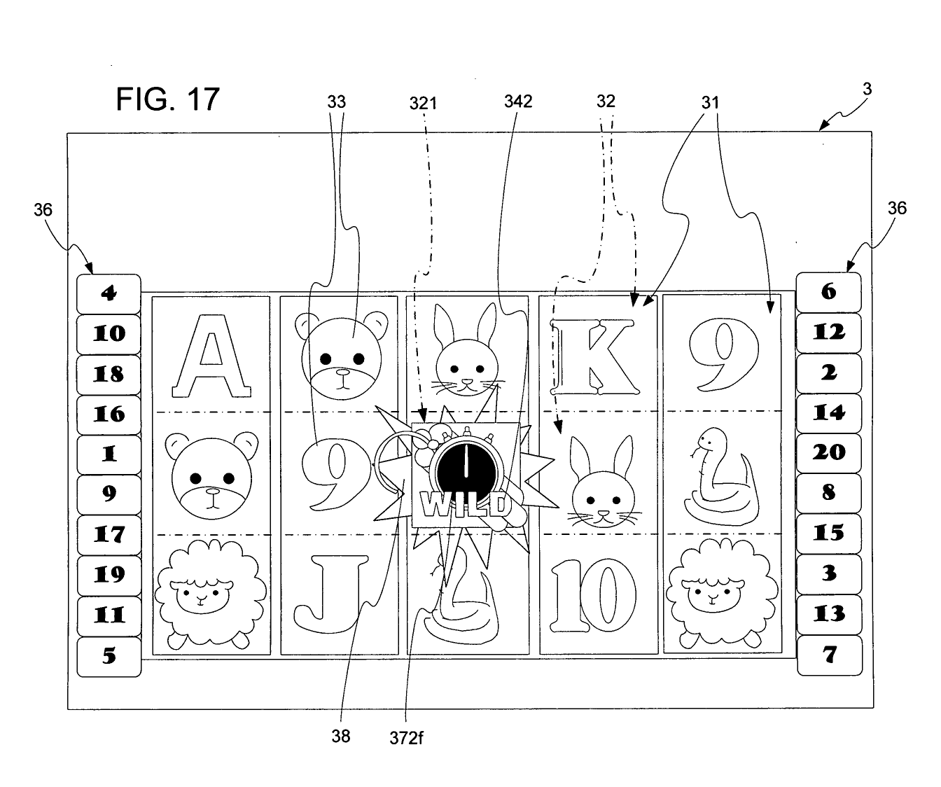

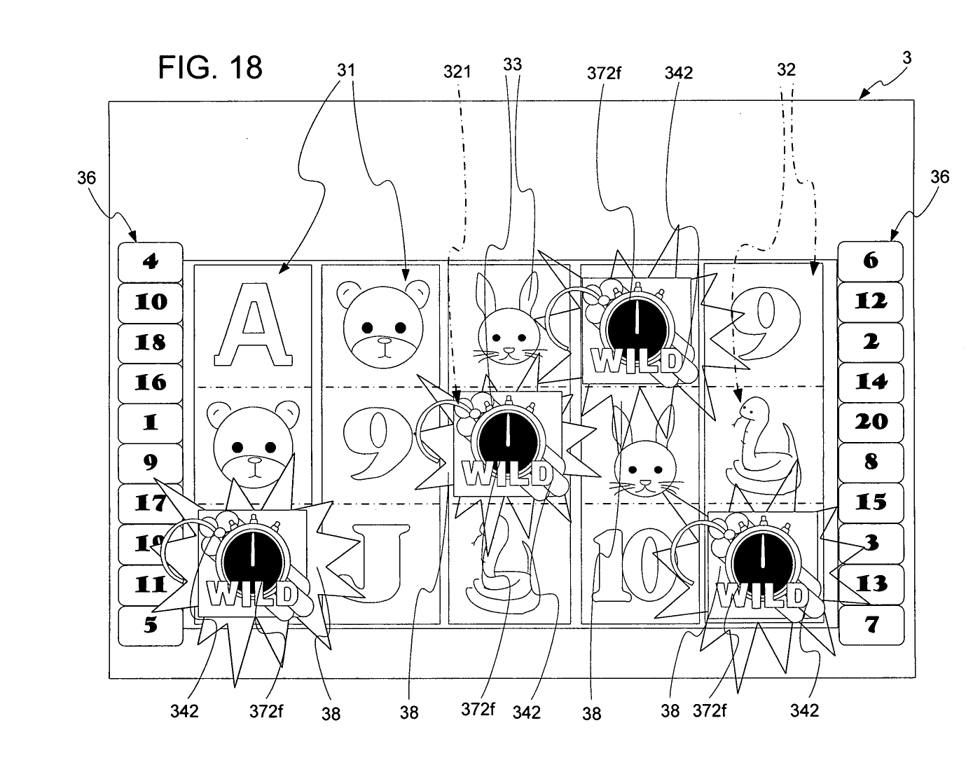

As shown in FIGS. 17 to 18, when the value of the gauge 372f has reached the threshold value, some of the symbols 33 in the display change into specific symbols 342, each of which functions as a wild symbol. In other words, the specific symbols 342 is duplicated and spread into other cells 32 when the gauge 372f has reached the threshold value. In this Example, where and how many specific symbols 342 appear are determined randomly in other word by mystery. In the case of FIG. 18, three of the symbols 33 have turned into the specific symbols 342 in the display 3.

### §5.2. OPERATION OF EXAMPLE 4

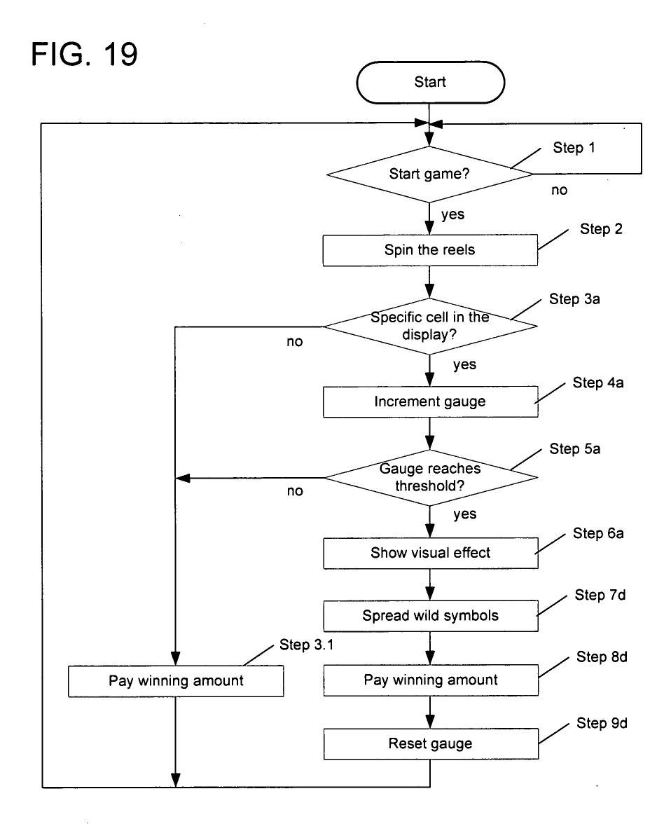

Below, only the operations that are different from those in Example 1 will be described, using FIG. 19.

<Steps 1-6a>: These steps are the same as the Steps 1-6a in Example 1. After showing the visual effect 38, the image on the display 3 may be the one as shown in FIG. 17.

<Step 7d>: The gaming machine 1 generates a random number and changes some of the symbols 33 in the display 3 into specific symbols 342 with visual effects 38 based on the random number generated. Then, the image on the display 3 may be the one as shown in FIG. 18.

<Step 8d>: The gaming machine 1 calculates the winning amount of the game, taking account the specific symbols 342 generated in the previous step.

<Step 9d>: The gaming machine 1 resets the value of the gauge 371f. Also, the gaming machine 1 turns the specific symbols 342 generated in Step 7d back to the original symbols 33.

### §5.3. ADVANTAGE OF EXAMPLE 4

In this Example, the specific symbol 341 was spread in the display 3. This catches a player's eye, and makes the game more dramatic. In addition, all the spread specific symbols 342 function as a wild symbol. Thus, this feature provides a chance for the player to acquire more winning lines and obtain a larger winning amount of credit. Therefore, the arrangement of the feature in this Example makes the game more exciting.

### §6. EXAMPLE 5

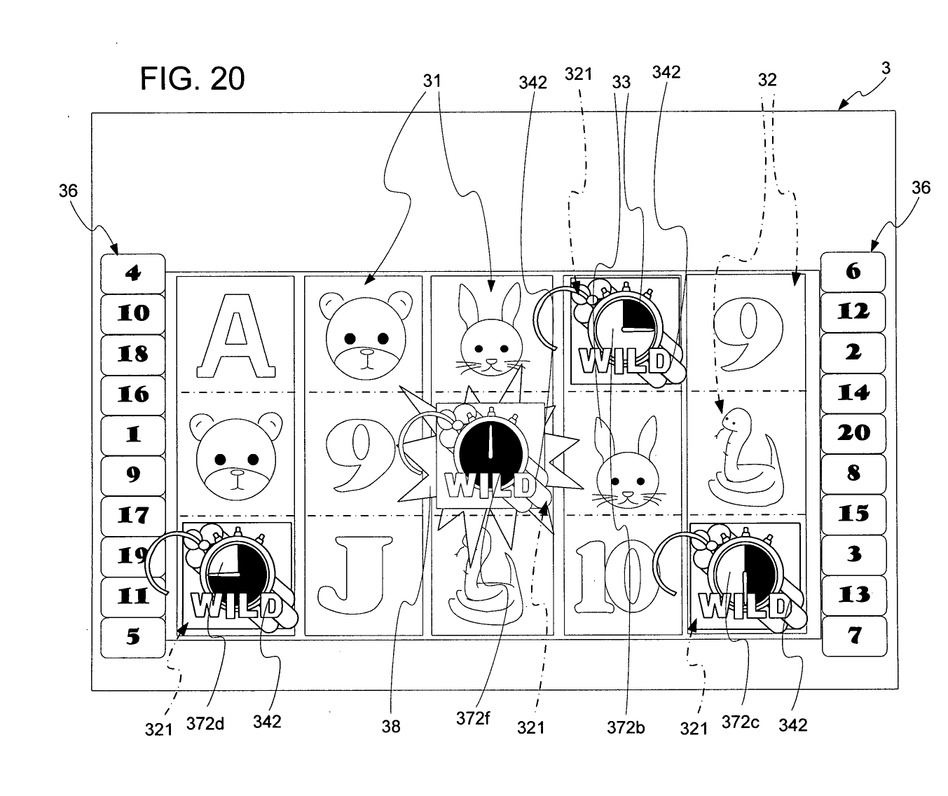

In this section, Example 5 will be explained, using FIGS. 20-23. Below, only the things that are different from the things in Examples 1 and 3 will be explained and the same explanations will be omitted.

### §6.1. DESIGN OF EXAMPLE 5

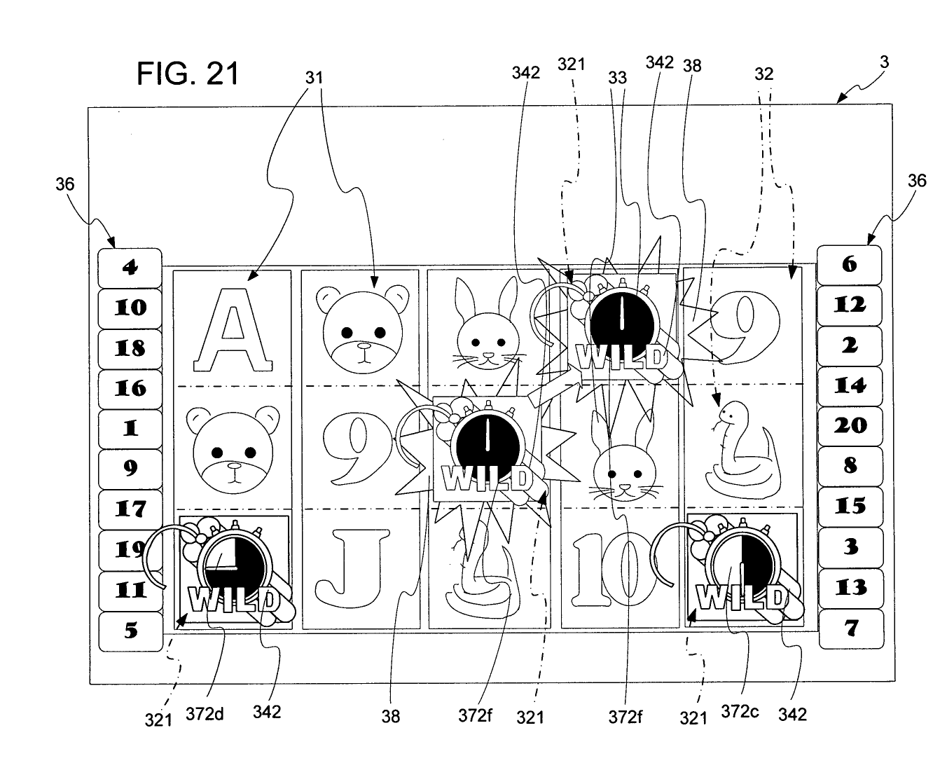

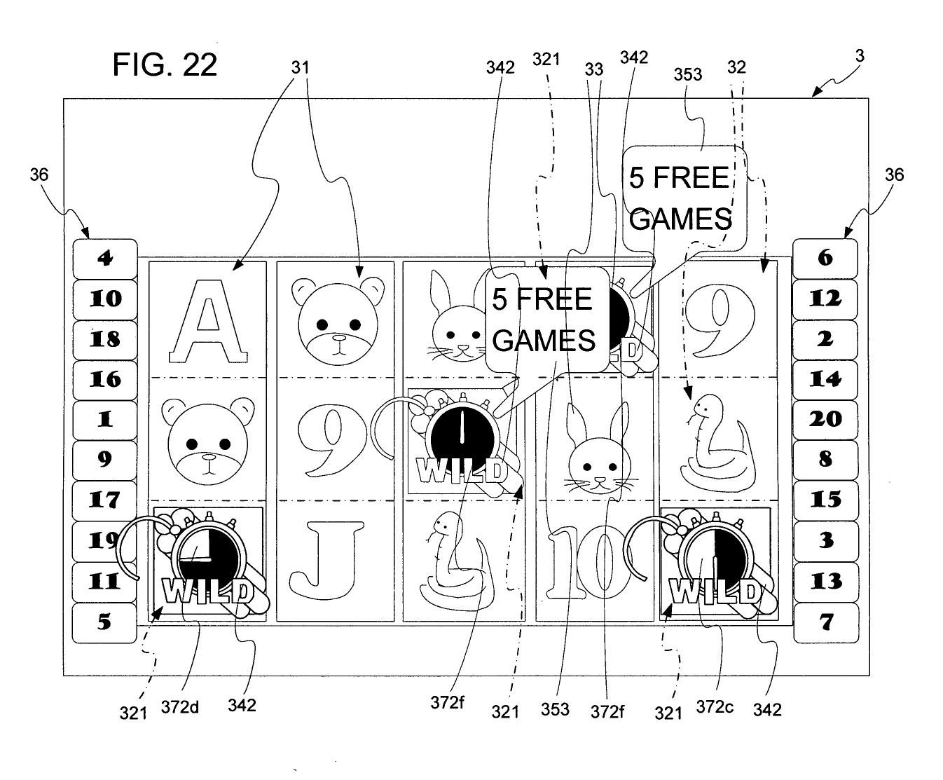

As shown in FIGS. 20 to 21, in this Example, when a gauge 372f has reached the threshold value, gauges 372 that are adjacent to the gauge 372f are influenced by the gauge 372f and their values are elevated to the threshold value. In the case of FIG. 20, a value of the gauge 372f at the center of the display 3 first reaches the threshold value. This causes an appearance of a visual effect 38 on the specific cell 321 in which the value of the gauge 372f has reached the threshold value. Subsequently, as shown from FIGS. 20 to 21, a value of the gauge 372b, which is adjacent to the gauge 372f at the center of the display 3, is increased to be the threshold value. This causes an appearance of another visual effect 38 as if the gauge 372b is induced to explode by the gauge 372f that is adjacent to the gauge 372b. Then, as shown in FIG. 22, messages 353 are provided from all the gauges 372f whose values have reached the threshold value. Then, free games are provided to the player as a feature. In this Example, the number of the free games provided to the player relates to the number of the gauges 372f whose value have reached the threshold value. In the case of FIG. 22, since two gauges 372f have reached the threshold value and each of the gauges 372f provides five free games, total ten free games are provided to the player.

In this specification, examples of the cells 32 that are adjacent to a specific cell 321 are the cells 32 that are located above, below, right or left from the specific cell 321 in a one-cell distance and the cells 32 that are located in upper right, upper left, lower right or lower left from the specific cell 321 in a two-cell distance.

### §6.2. OPERATION OF EXAMPLE 5

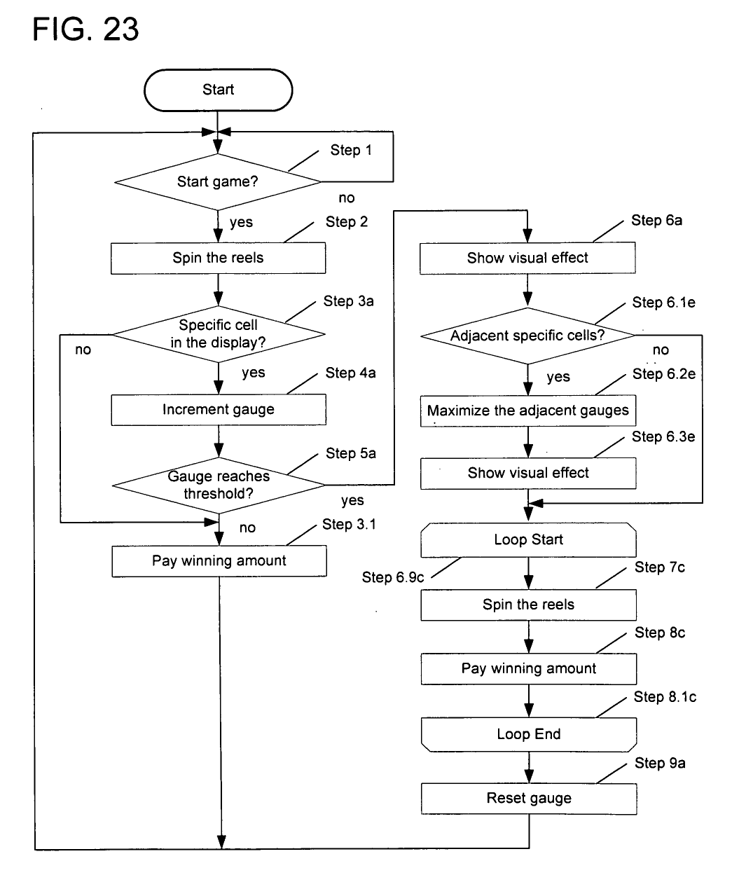

Below, only the operations that are different from those in Examples 1 and 3 will be described, using FIG. 23.

<Steps 1-6a>: These steps are the same as the Steps 1-6a in Example 1. After showing the first visual effect 38, the image on the display 3 may be the one as shown in FIG. 20.

<Step 6.1e>: The gaming machine 1 determines whether there is another specific cell 321 adjacent to the specific cell 321 whose gauge's value has reached the threshold value. If there is at least one other specific cell 321, the process proceeds to Step 6.2e. If there is no other specific cell 321, the process jumps to Step 6.9c.

<Step 6.2e>: The gaming machine 1 maximizes the value of the gauge 372 that is adjacent to the specific cell 321 whose gauge's value has reached the threshold value as shown in FIGS. 20 to 21.

<Step 6.3e>: The gaming machine 1 shows the visual effect 38 on the specific cell 321 whose gauge's value was maximized in the previous step. Then, the image on the display 3 may be the one as shown in FIG. 21. Next, the gaming machine 1 shows the messages 353 like FIG. 22.

<Steps 6.9c-9a>: These steps are the same as the Steps 6.9c-9a in Example 3.

### §6.3. ADVANTAGE OF EXAMPLE 5

In this Example, another specific cell 321, whose gauge's value hadn't reached the threshold value yet, was influenced by the adjacent specific cell 321 whose gauge's value had reached the threshold value. Then, the value of the gauge 372 in the another specific cell 321 was maximized. This gives the player an impression that one explosion of the specific symbol 342 induced the explosion of another specific symbol 342 nearby. Such event catches the player's eye and excites the player. Furthermore, the number of the free games provided to the player is increased. This delights the player, making the game more fun.

### §7. EXAMPLE 6

In this section, Example 6 will be explained, using FIGS. 20 & 24-26. Below, only the things that are different from the things in Examples 1 and 5 will be explained and the same explanations will be omitted.

### §7.1. DESIGN OF EXAMPLE 6

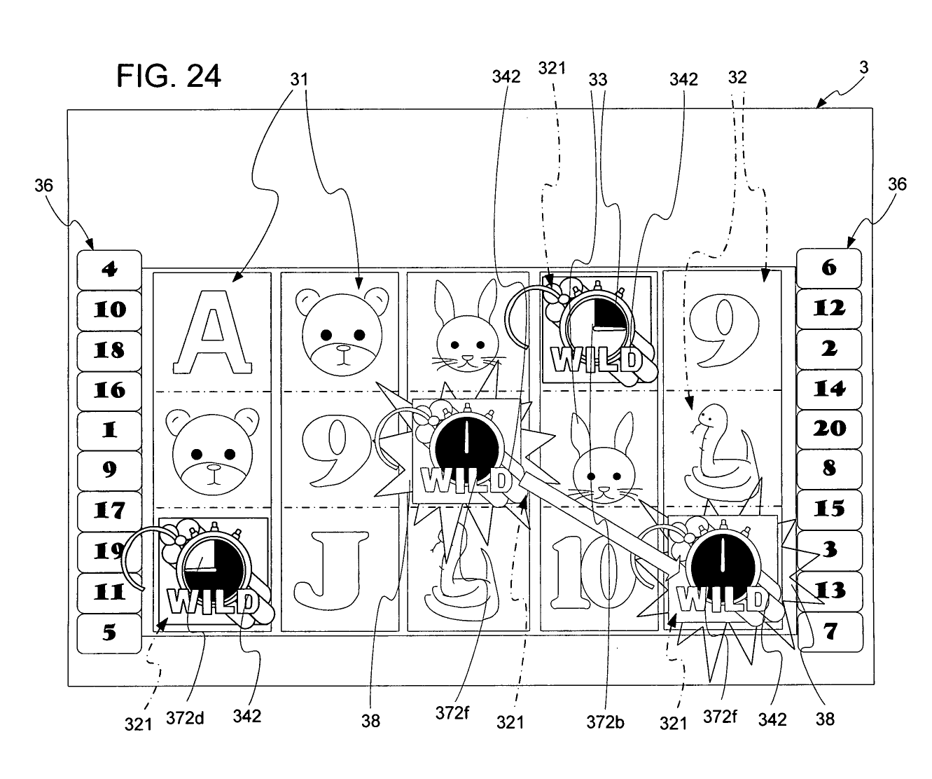

As shown in FIGS. 20 to 24, in this Example, when a value of a gauge 372f has reached the threshold value, the specific cell 321, whose gauge's value has reached the threshold, influences other specific cells 321 in the display 3, whose gauge's value is less than the threshold value. In this Example, however, which of the specific cells 321 is influenced is determined randomly, in other words, by mystery. Thus in the case of FIG. 20, there is a possibility that the gauge 372b, the gauge 372c or the gauge 372d can be influenced by the gauge 372f. In the case of FIG. 24, the specific cell 321 that is located at lower right in the display 3 has been influenced. And, its gauge's value has been elevated to be the threshold value, and the visual effect 38 is shown in this specific cell 321. Then, as shown in FIG. 25, the symbols 33 in the reels 31, in which the values of the gauges 372f have reached the threshold value, turns to entire reel wild symbols 351.

### §7.2. OPERATION OF EXAMPLE 6

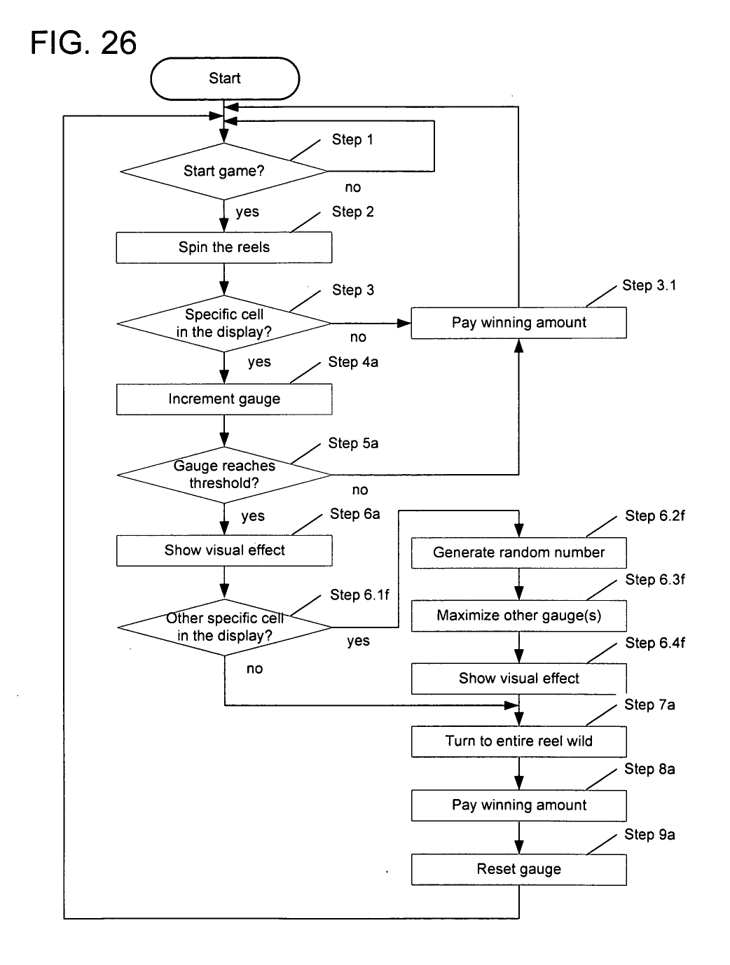

Below, only the operations that are different from those in Examples 1 and 5 will be described, using FIG. 26.

<Steps 1-6a>: These steps are the same as the Steps 1-6a in Example 5. At the stage of Stop 6a, the image on the display 3 may be the one as shown in FIG. 20.

<Step 6.1f: The gaming machine 1 determines whether there are other specific cells 321 in the display 3. If there is at least one other specific cell 321, the process proceeds to Step 6.2f. If there is no other specific cell 321, the process jumps to Step 7a.

<Step 6.2f: The gaming machine 1 generates a random number.

<Step 6.3f: Based on the random number generated, the gaming machine 1 elevates values of some of the gauges 372 in the display 3 to be the threshold value.

<Step 6.4f: The gaming machine 1 shows a visual effect 38 on the specific cell 321 whose gauge's value has reached the threshold value in the previous step. Then, the image on the display 3 may be the one as shown in FIG. 24.

<Steps 7a-9a>: These steps are the same as the Steps 7a-9a in Example 1. During one of these steps, the image on the display 3 may be the one as shown in FIG. 25.

### §7.3. ADVANTAGE OF EXAMPLE 6

In this Example, when there was at least one other specific cell 321 in the display 3, the specific cell 321 whose gauge's value had reached the threshold value, influenced other specific cell 321, whose gauge's value hadn't reached the threshold value yet. Which of the specific cell 321 was influenced was determined randomly. This makes the game more volatile.

### §8. EXAMPLE 7

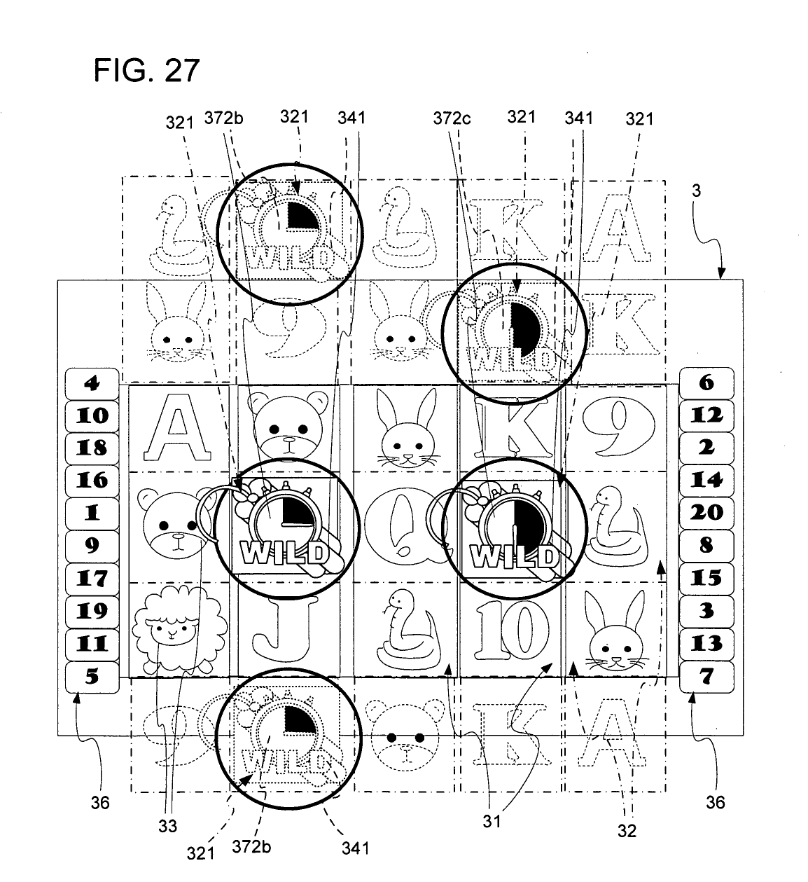

In this section, Example 7 will be explained, using FIGS. 27-30. Below, only the things that are different from the things in Example 1 will be explained and the same explanations will be omitted.

### §8.1. DESIGN OF EXAMPLE 7

In this Example, when the specific cell 321 shows up in the display 3, a value such as ‘one’ is added to all the gauges 372 in the reel 31 in which the specific cell 321 has appeared in the display 3. In other word, the value is added not only to the value of the gauges 372 in the display 3 but also the value of gauges 372 that are not shown in the display 3 but in the reel 31 in which the gauge 372 has appeared in the display 3. Thus, in FIG. 27, the values of the gauges 372b that are outside of the display 3 have also become ‘one’ in the reel 31 where the value of the gauge 372b has become ‘one’ in the display 3. Likewise, the value of the gauge 372c that are outside of the display 3 have also become ‘two’ in the reel 31 where the value of the gauge 372c has become ‘two’ in the display 3. Since a certain value is added in all the gauges 372 in one reel 31, the value of each gauge 372 in one reel 31 is the same.

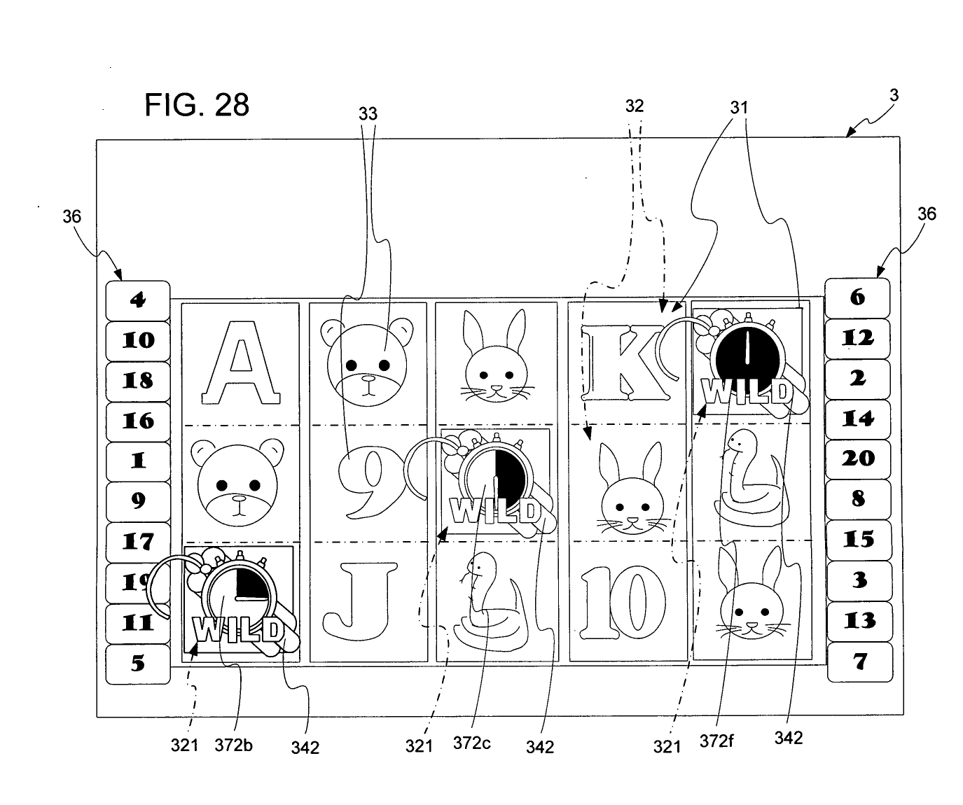

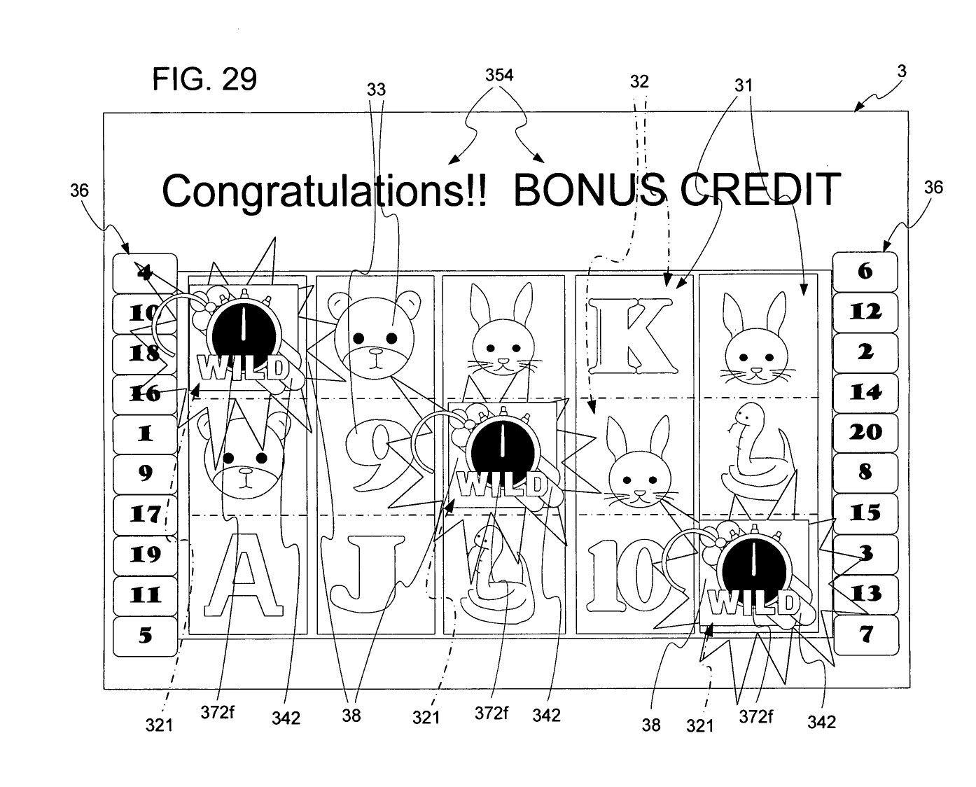

As shown in FIG. 28, when even the value of one of the gauges 372 reaches a threshold value, a feature is not initiated in this Example. However, as shown in FIG. 29, when the values of three gauges 372 reach the threshold value in the display 3, a feature is initiated. In this Example, the feature is a payout of a bonus credit, showing a message 354. After the payout of the bonus credit, the values of the gauges 372f, not only in the display 3 but also outside of the display 3, are reset to be a default value.

### §8.2. OPERATION OF EXAMPLE 7

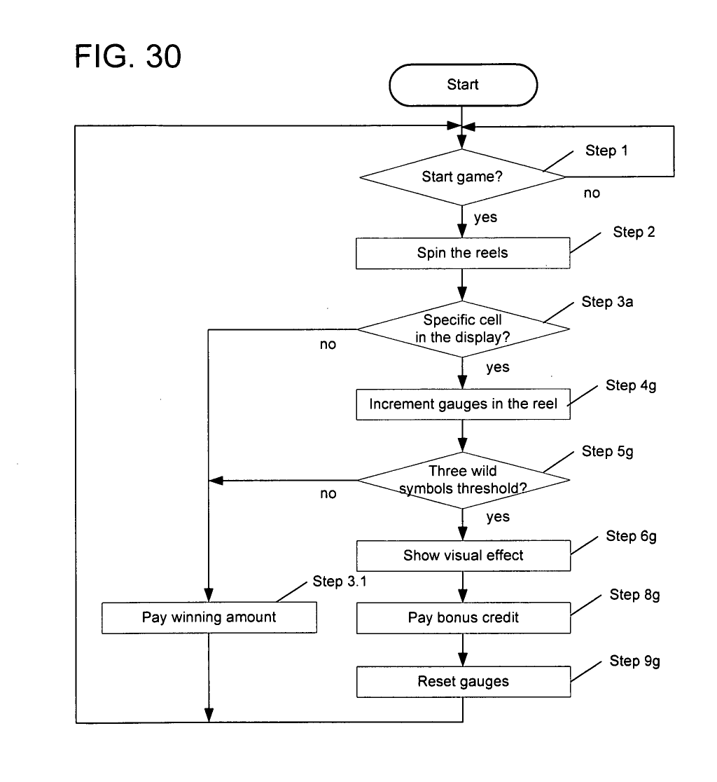

Below, only the operations that are different from those in Example 1 will be described, using FIG. 30.

<Steps 1-3a>: These steps are the same as the Steps 1-3a in Example 1.

<Step 4g>: The gaming machine 1 increments the value in the counter 221 that corresponds to the specific cell 321 that has been showed up in the display 3. At the same time, gaming machine 1 increments the value in the counter 221 that corresponds to the specific cell 321 that is not shown in the display 3 but that is in the reel 31 where the specific cell 321 has appeared in the display 3. Also, the gaming machine 1 reflects the values stored in the counter 221 to the gauge 372. Thereby, the time indicated by the gauge 372 may turn into 3 o'clock or 6 o'clock as shown in FIG. 27.

<Step 5g>: The gaming machine 1 compares the value of each gauge 372 with the threshold value and determines whether the values of three of the gauges 372 that have appeared in the display 3 have reached the threshold value. If the three values are the same or greater than the threshold value, the operation proceeds to Step 6g. Otherwise, the operation branches to Step 3.1. When the operation branches to Step 3.1, the display 3 may be like FIG. 28.

<Step 6g>: The gaming machine 1 shows the visual effect 38 as well as the message 354 as shown in FIG. 29.

<Step 8g>: The gaming machine 1 pays a bonus credit to the player. Also, the gaming machine 1 calculates and pays the winning amount of the credit as Step 3.1 in the Example 1.

<Step 9g>: The gaming machine 1 resets the values of all the gauges 372f whose value have reached the threshold value. Then, the operation goes back to Step 1.

### §8.3. ADVANTAGE OF EXAMPLE 7

In this Example, when a specific symbol 342 appears in the display 3, a certain value is added to the values of all the gauges 372 in the reel 31 where the specific symbol 342 has appeared in the display 3. Thus, the player can more often see the gauges 372 whose values are close to the threshold value. Therefore, the player would more often imagine that an exciting thing would happen soon.

However, the feature is finally initiated when the values of the three gauges 372f have reached the threshold value. This arrangement brings a unique fun taste to the game.

In this Example, bonus credits were given to the player as a feature. The amount of the bonus credit doesn't depend on the arrangement of the symbols 33. Therefore, even when the symbols 33 don't align on the activated pay lines to constitute a winning line, the player obtains the credit. This delights the player.

### §8.4. MISCELLANEOUS REMARKS

In this Example, the feature was initiated after three gauges 372f, whose values have reached the threshold value, have appeared in the display 3. However, in other examples, it may be arranged so that a feature occurs when two gauges 372f or more than three gauges 372f have appeared in the display 3. On the contrary, in other examples, it may be arranged so that a feature occurs when only one gauge 372 has appeared in the display 3.

In this Example, the feature was to provide a bonus credit. However, this feature may be replaced with any of the features described in the previous Examples.

### §9. MISCELLANEOUS REMARKS

Until the previous section, the present invention was described based on the specific Examples. However, this invention is not limited to the above Examples. Below are some examples of various modifications that are still within the range of this invention.

In the above Examples, a value was always added to the value of the gauge 371 or 372 when the gauge 371 or 372 appeared in the display. However, in other examples, the value may be added only when the player bets a certain amount of credit or higher for the game. Or, in other examples, the value may be added only when the player pays an extra bet.

In some of the above Examples, the entire reel wild symbol 351 turned back to the original symbols 33 after paying a credit. However, in other examples, the entire reel wild symbol 351 may remain in the display 3 for several spins.

In some of the above Examples, when the value of the gauge 371 or 372 has reached a threshold, the gaming machine 1 increased a winning chance by the appearance of the entire reel wild symbol 351 or change of some of the symbols 33 into the specific symbols 341 or 342. However, the way to increase the winning chance is not limited in these ways. For example, when same type of two symbols 33 are on a pay line, the gaming machine 1 may change one of the other symbols 33 into the same type of the symbol 33.

In some of the above Examples, the feature was a change of at least one type of a symbol 33 into another type of a symbol such as the entire reel wild symbol 351, the multiplier symbol 352 or the specific symbol 342. In other examples, the symbol 33 may change into any type of symbols such as a treasure symbol that brings a bonus credit to the player or a trigger symbol that triggers a secondary game.

In some of the above Examples, the influence to another specific cell 321 from the specific cell 321 whose gauge's value has reached the threshold value was to increase the value of the gauge 372 in the another specific cell 321 to be the threshold value. However, the influence is not limited to this. For example, in other examples, the influence may be an increase of a certain value of the gauge 372 in another specific cell 321.

In the above Examples, a favorable condition (advantageous condition) to a player was an appearance of the entire reel wild symbol 351, an appearance of the multiplier symbol 352, providing free games, spread of the specific symbols 342 or providing a bonus credit. The favorable condition to the player is, for example, a situation that leads the game to be advantageous for the player such as a situation that a possibility to win the game is elevated or a situation that a payout amount is enhanced. However, the favorable conditions to the players are not limited to these. In other examples, the favorable condition to the player may be providing a secondary game.

In the above Examples, only the value of the gauge 371 or 372 that involved in the feature was reset after the feature. However, in other examples, values of other gauges 371 or 372 that are not involved in the feature may be reset.

In the above Examples, the value of the gauge 371 or 372 was reset to a default value, which is ‘zero’, after the feature has been initiated. This arrangement makes the game easier to understand. However, in other examples, the value may not have to become the default value. For example, the value may be a randomly determined value such as ‘zero’, ‘one’ or ‘two’.

In the above examples, the specific type of symbols was the wild symbol. However, in other examples, the specific type of symbols can be any type of symbols. For example, the specific type of symbols can be a treasure symbol or a trigger symbol. Or, the specific type of symbols can be a symbol that represents a numeral, a letter or a picture.

In the above Examples, the visual effect 38 was shown when the gauge 371 or 372 had reached a threshold value. Such visual effects entertain the player. However, the visual effect 38 is not essential and it is feasible even not to show a visual effect when the gauge 371 or 372 reaches a threshold or before initiating the feature.

In the above Examples, the value of the gauge 371 or 372 was incremented when the specific symbol 341 or 342 showed up in the display 3. In other words, a value ‘one’ was added to the value of the gauge 371 or 372. However, it is feasible to add more than ‘one’ value to the value of the gauge 371 or 372.

In the above Examples, the gaming machine 1 had five reels and three symbols per reel in the display 3. However, the organizations of the reels and symbols are not limited to the above Examples. For example, it is feasible to have three reels or five symbols per reel.

In the above Examples, the controller 2 is designed to control the gaming machine 1 by the mechanism that the internal CPU 21 runs the programs stored in the memory 22. However, the architecture of the controller 2 is not limited to this organization. For example, it is feasible even if the controller 2 doesn't have a CPU 21 or memory 22. It is feasible even if the controller is made of other types of electrical devices, mechanical devices or a combination of them.

Embodiments of the present invention have been explained based on the Examples of a standard video slot. However, this invention is also applicable to other types of video slots such as hexagon type, scatter reel type and other types of video slot machines.

In the end, embodiments of the present invention have been explained based on the video slot Examples. However, this invention is also applicable to mechanical slot machines, pachisuro and any other gaming machines.

What is claimed is:

1. A gaming machine comprising:
a display, which shows symbols that are placed in cells, the symbols containing a specific type of symbol that is placed in a specific cell; and
a controller, which controls movements of the symbols and the cells;
wherein the specific cell has a gauge;
wherein a value indicated by the gauge represents a count of how many times the specific cell appears in the display;
wherein the controller compares the value of the gauge with a threshold value; and
wherein a favorable condition to a player is arranged to be initiated when the value of the gauge has reached the threshold value.

2. The gaming machine according to claim 1, wherein the favorable condition to the player includes a change of at least one type of symbol into another type of symbol.

3. The gaming machine according to claim 2, wherein the symbols are aligned in rows across reels; and
wherein the another type of symbol is a symbol that functions as a wild symbol in all the rows in a reel where the specific type of symbol has appeared.

4. The gaming machine according to claim 2, wherein the another type of symbol functions as a multiplier symbol.

5. The gaming machine according to claim 1, wherein the favorable condition to the player is a free game.

6. The gaming machine according to claim 1, wherein the favorable condition to the player is a change of a symbol into the specific type of symbol.

7. The gaming machine according to claim 1, wherein the display shows a plurality of specific cells, each of which has a gauge; and
wherein the favorable condition to the player is an influence to another specific cell from the specific cell whose gauge's value has reached the threshold value.

8. The gaming machine according to claim 7, the influence is to increase the value of the gauge in the another specific cell to be the threshold value.

9. The gaming machine according to claim 7, wherein the another specific cell, which is adjacent to the specific cell, is influenced.

10. The gaming machine according to claim 7, wherein when a plurality of another specific cells are shown in the display, another specific cell to be influenced is determined randomly.

11. The gaming machine according to claim 1, wherein the value of the gauge is reset to a default value after the favorable condition to the player has been initiated.

12. The gaming machine according to claim 1, wherein the symbols are aligned on a reel;
wherein the display shows a plurality of specific cells, each of which has a gauge; and
wherein a value of each gauge in the reel changes independently from a value of another gauge.

13. A gaming machine comprising:
a display, which shows symbols aligned along reels; the symbols containing a specific type of symbols; and
a controller, which controls movements of the symbols;
wherein each of the specific type of symbols has a gauge, the gauge indicating a value;
wherein when one of the specific type of symbols appears in the display, a certain value is added to values of gauges of specific type of symbols in a reel where the one of the specific type of symbols has appeared in the display;
wherein the controller compares the values of the gauges with a threshold value; and
wherein a favorable condition to a player is arranged to be initiated when a value of one of the gauges has reached the threshold value.

14. The gaming machine according to claim 13, wherein the favorable condition to the player is initiated when values of a plurality of the gauges has reached the threshold value.

15. A gaming machine comprising:
a display, which shows groups of symbols that contain at least a specific type of symbols, the symbols being aligned along a plurality of reels;
a controller, which controls movements of the reels on the display;
a counter, which counts numbers of times that the specific type of symbols appears on the display, the appearance of the specific type of symbols owing to the movement of the reels;
a plurality of gauges, each of which is placed in a symbol area where each of the specific type of symbols is located, each of the gauges reflecting each of the numbers counted by the counter; and
a memory, which memorizes the numbers counted by the counter;
wherein when at least one of the numbers in the memory has reached a threshold, the controller increases a winning chance by changing symbols in the reel whose associated number in the memory has reached the threshold.

16. The gaming machine according to claim 15, wherein the counter counts the number after one of the specific type of symbols has appeared on the display first time.

17. The gaming machine according to claim 15, wherein when one of the specific type of symbols has appeared on the display, the counter reflects all the numbers associated with the reel where the one of the specific type of symbols has appeared on the display.
